(19) United States
(12) Patent Application Publication
(10) Pub. No.: US 2015/0217327 A1
(43) Pub. Date: Aug. 6, 2015

(54) ENCLOSING SUBSTANCES IN MEMBRANES

(71) Applicant: WIKIFOODS, INC., Cambridge, MA (US)

(72) Inventors: David A. Edwards, Boston, MA (US); Laurent Robert Adrien Milon, Paris (FR); Heloise Vilaseca, Paris (FR); Cecile Poirier, Villejuif (FR)

(21) Appl. No.: 14/421,553

(22) PCT Filed: Aug. 14, 2013
(86) PCT No.: PCT/US2013/055000

§ 371 Date: Feb. 13, 2015

Related U.S. Application Data
(60) Provisional application No. 61/684,067, filed on Aug. 16, 2012.
(60) Provisional application No. 61/712,575, filed on Oct. 11, 2012.
(60) Provisional application No. 61/860,710, filed on Jul. 31, 2013.

(51) Int. Cl. B05D 1/18; B05C 3/02; B05C 13/00; B65D 65/46

(52) U.S. Cl. CPC B05D 1/18; B65D 65/463; B05C 3/02; B05C 13/00

(57) ABSTRACT

Systems (200) and methods for enclosing substances in an edible membrane can include raising and lowering the substances out of multiple fluid vessels (372), (374).

### RELATED APPLICATIONS

This application claims the benefit of U.S. Provisional Application No. 61/684,067, filed Aug. 16, 2012, U.S. Provisional Application No. 61/712,575, filed Oct. 11, 2012, and U.S. Provisional Application No. 61/860,710, filed Jul. 31, 2013. Each of the aforementioned applications is incorporated by reference in its entirety herein.

### TECHNICAL FIELD

This disclosure relates to making vessels for transporting materials (e.g., vessels for transporting fluids).

### BACKGROUND

Mankind has filled, carried, and transported water and other liquids (as well as solids, emulsions, slurries, foams, etc.) in vessels made of pottery, glass, plastics and other materials since prehistoric times. While the nature of these vessels has evolved with advances in material manufacture and design, the basic principle of a vessel comprised of a container comprising a surface that encloses the liquid, either partially or completely, and from which the liquid can be removed, emptying the vessel, which can be refilled, has essentially not varied. Users continue to fill and empty containers with water and other liquids for various practical purposes.

### SUMMARY

Systems used to transport substances (e.g., consumable substances such as foods, drinks, medicines, etc.) can include containers (e.g., edible containers). The containers can be single or multi-layer containers (e.g., 1, 2, 3, 4, etc. layers). The containers can be formed of substances (e.g., consumable substances) conducive to transportation and consumption. Layer(s) of the containers can be edible, providing benefits (e.g., nutritional benefits, etc.) as well as reducing concerns about, for example, littering, solid waste management, etc.

Embodiments of our systems can be manufactured by forming a container (e.g., a shell, etc.) around a volume (e.g., a serving) of a substance (e.g., a consumable substance such as a food, drink, medicine, etc.). In some cases, the container is formed around a volume of a substance or substances (e.g., solid, semi-solid, liquid substance(s)). The consumable substance may be solid at room temperature or may be treated (e.g., to heat, to chill, to freeze, etc.) the volume. In some cases, the container contains a volume (e.g. a serving) of a liquid substance (e.g., a liquid consumable substance, etc.).

The container can include a layer formed by a membrane forming solution(s) such as, for example, alginate, chitosan, etc., activated by contacting the membrane forming solution with an activating agent such as, for example, a divalent or trivalent metal solution (e.g., calcium, magnesium, etc.). In some cases, the volume of the substance (referred to in some instances as the payload) can act as an activating agent, e.g. when contacted by the membrane forming solution(s). The membrane forming solution(s), the activating agent, and container components may be applied using a fluid vessel, a spray, vapor deposition, etc.

In one aspect, systems for enclosing a substance in an edible membrane may include: a first station having a reservoir, the first station operable to lower a portion of the substance into the reservoir of the first station and then raise the portion of the substance out of the reservoir of the first station; a second station having a reservoir, the second station operable to lower the portion of the substance into the reservoir of the second station and then raise the portion of the substance out of the reservoir of the second station; and a mechanism connecting the first station and the second station operable to transfer the portion of the substance between the first station and the second station.

In some embodiments, the first station may comprise a cage moveable between a first position in which the cage is disposed in the reservoir of the first station and a second position in which the cage is disposed at least partially outside the reservoir of the first station. In some cases, the first station comprises at least one piston operable to position the cage. In some cases, the cage may comprise members at least partially defining an interior space, the members defining openings through which fluid can flow as the cage is raised out of and lowered into the reservoir of the first station.

In some embodiments, the mechanism connecting the first station and the second station may comprise a slanted chute extending between the first station and the second station.

In some embodiments, the reservoir of the second station is configured to contain a temperature reducing agent (e.g., liquid nitrogen, other liquefied gases, etc.).

In one aspect, systems for enclosing a substance in an edible membrane may include a plurality of stations for sequentially receiving, transferring, and processing an edible or potable flowable substance. The receiving, transferring and processing completed by the plurality of stations encapsulate the edible or potable flowable substance in at least one edible or biodegradable membrane.

In some embodiments, the plurality of stations (e.g., 1, 2, 3, 4, 5, etc. stations) can include at least one first station and at least one second station. The first station could receive the flowable substance from at least one inlet and contact the substance with at least one component of the edible or biodegradable membrane. The second station can receive the substance from the first station and contact the substance with at least one other component of the edible or biodegradable membrane, wherein contacting the substance with the at least one other component forms an edible or biodegradable membrane.

In some embodiments, the at least one component in each of the first and second stations may include a fluid vessel, spray and/or vapor. For example, the first station may be a fluid vessel of calcium, magnesium, manganese or other appropriate divalent metal solution or a trivalent metal solution, and the second station fluid vessel can include an alginate solution, chitosan solution, or other membrane forming solution. In some embodiments, the first station fluid vessel includes an alginate, chitosan or other membrane forming solution and the second station fluid vessel includes a fluid vessel of calcium, magnesium, manganese or other appropriate divalent metal solution or trivalent metal solution.

In some embodiments, the at least one component of the edible or biodegradable membrane in the first station and the at least one other component of the edible or biodegradable membrane in the second station form a stable membrane via an intramembranous salt-bridge network. In some embodiments, the edible or biodegradable membrane includes solid, edible particulates. The particulates may be the zwitterionic, same charge, neutral charge, opposite charge, etc. of the membrane or membrane components.

In some embodiments, an edible or biodegradable flowable substance includes in the matrix of the substance solid, edible particulates.

In some embodiments, the systems include an automated mechanism to transfer the substance from the first station to the second station.

In some embodiments, the first station may include a receptacle to receive the edible or potable substance from the at least one extrusion inlet. In some embodiments, the receptacle is a movable and/or detachable part of a transfer system. The receptacle can be hemispherical, pyramidal, ovoid, cubic, other appropriate geometric shape, etc. The receptacle may oscillate with a controllable horizontally linear and/or circular displacement and rate.

In some embodiments, the systems may include an extrusion system including at least one extrusion port operable to dispense, for example, flowable substance, membrane forming material etc. into a first station (e.g., into a fluid vessel of the first station or above a fluid vessel, whereupon an edible or potable substance is dropped into a fluid vessel). In some cases, the extrusion system may include at least two concentrically located extrusion ports operable to dispense at least two edible or potable flowable substances into the first station (e.g., a fluid vessel of the first station). In some cases, the extrusion system may include at least two extrusion ports, a mouth of at least one inner extrusion port being located within a boundary circumscribed by a mouth of an outer extrusion port. In some cases, the outer extrusion port of a concentrically designed plurality of extrusion ports delivers a membrane-forming component and the at least one inner port delivers the edible or potable flowable substance. In some embodiments, the outer and inner extrusion ports of a plurality of extrusion ports may have different flow rates for the substances extruded from the extrusion ports. In other embodiments, the extrusion port muzzles of concentrically located extrusion ports are located in the same plane or at least one extrusion port muzzle is located above the plane or below the plane defined by at least one other extrusion port muzzle in the concentrically located extrusion ports. In other embodiments the extrusion nozzles are electrically charged, having a charge pole opposite that of a receptacle to which substances are disposed by the nozzle. The extrusion nozzles may oscillate with a controllable horizontally linear and/or circular area displacement and rate.

In certain aspects, an extrusion system may comprise extrusion ports located above a fluid vessel or below the surface top of a fluid vessel and oriented downward wherein the substance delivered by the nozzle flows in a vertically downward motion into or onto the fluid vessel, forming a pendant like edible or biodegradable structure. In other certain aspects, the extrusion system may comprise extrusion ports located at the bottom most portion of a fluid vessel and/or reservoir and oriented upward wherein a substance delivered by the nozzle flows in a vertically upward motion into the fluid vessel, forming a sessile-like edible or biodegradable structure.

Some embodiments of the present invention include substance delivery hoses, lines or pipes connecting a supply reservoir to the nozzle. The hoses, pipes or lines may be coated with materials to impede or enhance flowability of substances. In other embodiments the hoses pipes or lines can be charged the same, neutrally, or opposite that of the substances flowing through the delivery vessels.

In some embodiments, the edible or biodegradable outer membrane can be an alginate composition, a chitosan composition, other biodegradable and/or edible charge polymer membranes, etc.

In some embodiments, the plurality of stations can include at least one first station (e.g., 1, 2, 3, 4, etc. first stations) and at least one second station (e.g., 1, 2, 3, 4, etc. first stations). The first station(s) can receive the edible or potable substance from at least one inlet. The substance may include at least one component of the edible or biodegradable membrane. The first station(s) can then contact the substance with at least one other component of the edible or biodegradable membrane. The second station(s) can receive the substance encased in an edible or biodegradable membrane from the first station. In some cases, the at least one component of the edible or biodegradable membrane is a solubilized calcium, magnesium or manganese, and the at least one other component of the edible or biodegradable membrane is an alginate solution.

In other embodiments, the plurality of stations can include a wash station wherein the substance is washed between transfers to other stations, for example between an alginate bath station and a calcium bath station. In certain embodiments the fluid reservoirs of a station can be further comprised of a filter system sufficient to filter out macroscopic particulates.

In some embodiments, the first station can have a first reservoir; the second station can have a second reservoir, and a substance removal mechanism can operably transfer an edible or potable substance between the first station and the second station. The mechanism can be operable to lower a receptacle into the first reservoir, raise the receptacle out of the first reservoir of the first station, and guide the receptacle to transfer the substance from the first station to the second station. The substance removal mechanism can be operable to selectively remove a portion of the substance out of a fluid in the second reservoir of the second station.

In some embodiments, the first and second reservoirs are independently replaceable.

In some embodiments, the receptacle comprises a polytetrafluoroethylene or other food grade non-stick surface. In some embodiments, the receptacle can be comprised of food grade plastics or metals, including stainless steel. The receptacle can include at least one cell or a plurality of cells. The cell or plurality of cells can be any shape or size, including, but not limited to, a hemispherical shape. Edges or lips of the cells can be beveled rounded or angular. In some embodiments, the mechanism can include a guide channel and gears configured to engage the receptacle to rotate the receptacle about an axis perpendicular to the guide channel.

In some embodiments, the systems can include an extrusion system operable to dispense fluids into the receptacle. In some cases, an extrusion system can include an extrusion reservoir configured to contain a substance and is operable to deliver a substance into a receptacle via at least one outlet. In some cases, an extrusion reservoir is in fluid communication with at least one piston configured to deliver the substance from the reservoir via the at least one reservoir outlet. In other embodiments, a plurality of pistons in fluid communication with individual extrusion reservoirs are each configured to deliver a substance to a delivery nozzle. In still other embodiments, the pistons can be individually controlled for rate of displacement and/or pulsed displacement.

In some cases, extrusion reservoirs can be removable from the system. In some cases, the extrusion system is operable to be raised and lowered onto the receptacle. Some embodiments include lowering the extrusion system into a fluid vessel of a station.

In yet another aspect, a method includes lowering an edible or potable substance at above a melting point of the edible or potable substance into a first liquid bath and coating the edible or potable substance with a first liquid including a gelling precursor; raising the coated edible or potable substance from the first liquid bath; lowering coated the edible or potable substance into a second liquid bath and forming a membrane over the edible or potable substance, and raising the membrane-coated edible or potable substance from the second liquid bath. The membrane is structurally stable at room temperature.

In some embodiments, the gelling precursor includes alginate.

In some embodiments, lowering the edible or potable substance into the second liquid bath includes lowering the edible or potable substance into a calcium solution.

In some embodiments, forming the membrane includes crosslinking the gelling precursor.

In one aspect, systems for enclosing a substance in an edible membrane can include: a first station having: a first inlet that receives an edible or potable substance; a first cage that is connected to a first transfer mechanism, the transfer mechanism configured to raise and lower the cage into a first fluid vessel; and a first outlet that receives the edible or potable substance from the first cage, the first outlet being arranged at a generally lower vertical position than the first inlet relative to the first fluid vessel; and a second station having: a second inlet that receives the edible or potable substance from the first outlet; a second cage that is connected to a second transfer mechanism, the transfer mechanism configured to raise and lower the cage into a second fluid vessel; and a second outlet that receives the edible or potable substance from the second cage, the second outlet being arranged at a generally lower vertical position than the second inlet relative to the second fluid vessel.

Embodiments can include one or more of the following features.

In some embodiments, the first transfer mechanism includes one or more pistons.

In some embodiments, systems may also include a chute extending between the first outlet and the second inlet.

In some embodiments, systems may also include a third station having: a third inlet that receives an edible or potable substance; a third cage that is connected to a third transfer mechanism, the third transfer mechanism configured to raise and lower the cage into a third fluid vessel; and a third outlet that receives the edible or potable substance from the third cage, the third outlet being arranged at a generally lower vertical position than the third inlet relative to the third fluid vessel.

In some embodiments, the second station can be configured to contain liquid nitrogen or other liquefied gases.

In some embodiments, the first cage may include members at least partially defining an interior space, the members defining openings through which fluid can flow as the first cage is raised out of and lowered into the first fluid vessel. In some cases, the members at least partially defining the interior space can comprise perforated sheets (e.g., metal sheets, food grade plastic sheets, etc.).

In one aspect, methods can include: lowering an edible or potable substance into a first liquid bath and coating the edible or potable substance with a first membrane that is substantially impermeable to the edible or potable substance at room temperature; raising the cooled edible or potable substance from the first liquid bath; lowering the cooled edible or potable substance in the first membrane into a second liquid bath and coating the cooled edible or potable substance in the first membrane with a second membrane that is structurally stable at room temperature; and raising the cooled edible or potable substance in the first and second membranes from the second liquid bath. Embodiments can include one or more of the following features.

In some embodiments, methods can also include immersing the edible or potable substance in a cooling agent (e.g., liquid nitrogen, etc.). In some cases, the step of immersing the edible or potable substance in the cooling agent (e.g., liquid nitrogen, etc.) may occur after raising the cooled edible or potable substance from the first liquid bath and before lowering the edible or potable substance into the second liquid bath. Lowering the edible or potable substance into the second liquid bath can include lowering the edible or potable substance into a membrane forming solution (e.g., an alginate solution). Lowering the edible or potable substance into the first liquid bath can include lowering the edible or potable substance into a gelling solution. Methods can also include lowering the edible or potable substance into a gelling solution after lowering the edible or potable substance into a membrane forming solution.

In some embodiments, methods may include solidifying (e.g., by freezing or other process for increasing the viscosity) the edible or potable substance before the lowering the edible or potable substance into the first liquid bath.

In some aspects, systems include: a plurality of stations for sequentially receiving, transferring, and processing a consumable flowable substance, wherein the receiving, transferring and processing encapsulate the consumable flowable substance in at least one edible or biodegradable membrane. Embodiments can include one or more of the following features.

In some embodiments, the plurality of stations comprises: at least one first station, the first station receiving the consumable substance from at least one inlet, wherein the substance is contacted with at least one component of the edible or biodegradable membrane; at least one second station, the second station receiving the substance from the first station; and a transfer mechanism to transfer the substance between the first station and the second station. In some cases, the at least one edible or biodegradable component in each of the first and second stations comprises a fluid vessel. The first station fluid vessel can comprise an alginate solution and the second station fluid vessel comprises a calcium solution. The first station fluid vessel can comprise a calcium solution and the second station fluid vessel comprises an alginate solution.

In some embodiments, at least one component of the edible or biodegradable membrane is a solubilized multivalent cation and the at least one other component of the edible or biodegradable membrane is a polysacharride polymer solution. In some cases, the at least one component of the edible or biodegradable membrane and the at least one other component of the edible or biodegradable membrane form a stable membrane via a salt-bridge network.

In some aspects, systems for enclosing a consumable substance in a membrane include: a first station operable to lower a portion of the substance into a first fluid vessel and then raise the portion of the substance out of the first fluid vessel; a second station operable to lower the portion of the substance into a second fluid vessel and then raise the portion of the substance out of the second fluid vessel; and a transfer mechanism to transfer the substance between the first station and the second station.

In some embodiments, the first fluid vessel is a component of the first station and the second fluid vessel is a component of the second station.

In some embodiments, systems include a fluid-displacing insert disposed in the first fluid vessel. In some cases, a cross-section of a portion of the insert increases with increasing distance from a floor of the first fluid vessel. In some cases, the first and second reservoirs are independently replaceable.

In some embodiments, the transfer mechanism comprises a receptacle having a first position disposed within the first fluid vessel. In some cases, the transfer mechanism is operable to move the receptacle in and out of the first fluid vessel. In some cases, the receptacle comprises a first surface and an opposite second surface and the receptacle defines at least one cell in the first surface and at least one opening extending from each cell to the second surface. In some cases, the receptacle defines multiple cells in the first surface. In some cases, the at least one cell is defined at least in part by a semi-spherical surface. In some cases, the receptacle defines at least one smooth lateral notch in each cell. In some cases, the transfer mechanism further comprises a guide channel and gears configured to engage the receptacle to rotate the receptacle about an axis perpendicular to the guide channel. In some cases, the transfer mechanism is operable to automatically transfer the receptacle from the first station to the second station.

In some embodiments, systems include an extrusion system comprising a first port, a conduit, and a reservoir. In some cases, the first port is operable to dispense the flowable substance into the first station. In some cases, the extrusion system further comprises at least one second port concentrically located with the first port. In some cases, a mouth of a first port is located within a boundary circumscribed by a mouth of the second port. In some cases, the second port delivers a membrane forming component. In some cases, the second ports delivers a consumable flowable substance. In some cases, the extrusion system comprises a plurality of first ports and a plurality of second ports, one or more of the first ports concentrically located with one of the second ports, particularly wherein each of the first ports concentrically located with one of the second ports. In some cases, at least one of the plurality of first and second ports delivers a membrane forming component.

In some embodiments, the reservoir is configured to contain the substance and is operable to deliver the substance into the receptacle via at least one conduit and at least one outlet. In some cases, the reservoir is in fluid communication with at least one piston, and the piston is in fluid communication with a conduit. In some cases, the piston is in fluid communication with a plurality of conduits. In some cases, the extrusion system comprises a conduit connected to a first port and a different conduit connected to a second port.

In some embodiments, the extrusion system is heated or refrigerated. In some cases, the extrusion reservoir is removable from the system. In some cases, the extrusion system port is moveable relative to the first fluid vessel. In some cases, the extrusion system port is operable to translationally oscillate relative to the first fluid vessel.

In some embodiments, systems include a substance removal mechanism operable to selectively remove a portion of the substance out of a fluid in the second fluid vessel.

In some cases, the substance removal mechanism comprises a removable tray. In some cases, the removable tray comprises drainage holes.

In some embodiments, the flowable substance further comprises solid, edible particles.

In some embodiments, systems include a filtration system to remove macroparticulates from the first and/or second fluid vessel.

In some embodiments, systems include a sensing device to monitor the concentration of multivalent ions in the first or second fluid vessel. In some cases, the sensing device monitors pH, conductance, fluid levels, temperatures, or pressures in a portion of the system.

In some embodiments, systems include a station for treating the membrane coated consumable product with a consumable liquid or consumable powder.

In some aspects, methods include: extruding a consumable substance into a first liquid bath and coating the consumable substance with a first liquid comprising a membrane forming precursor; raising the coated consumable substance from the first liquid bath; lowering the coated consumable substance into a second liquid bath to form a membrane covering the consumable substance; and raising the membrane-coated consumable substance from the second liquid bath.

In some aspects, methods include: extruding a consumable substance into a first liquid bath, wherein extruding coats the consumable substance with a first membrane forming precursor, and wherein the first bath contains a second membrane forming precursor to form a membrane covering the consumable substance; and raising the coated consumable substance from the first liquid bath.

In some embodiments, the gelling precursor comprises alginate.

In some embodiments, lowering the consumable substance into the second liquid bath comprises lowering the consumable substance into a calcium solution.

In some embodiments, forming the membrane comprises crosslinking the gelling precursor.

In some embodiments, methods include the steps of: lowering coated the consumable substance into a second liquid bath containing the first membrane forming precursor; raising the coated consumable substance from the second liquid bath; lowering the coated consumable substance into the first liquid bath; and raising the membrane-coated consumable substance from the first liquid bath.

In some embodiments, methods include the step of treating the membrane covered consumable product with a consumable liquid or consumable powder.

In some embodiments, a system for transferring a payload between fluid baths, comprises: a first fluid bath; a second fluid bath; a first arm extending from a pivot axis to a first pivot point, the first arm being rotatable about the pivot axis; and a transfer assembly attached to the first arm at the first pivot point, the transfer assembly being rotatable about the first pivot point and comprising (i) a first bar extending from the first pivot point to a first beam and (ii) a second bar extending from the first pivot point to a second beam, the second beam being parallel to the first beam.

In some embodiments, the transfer assembly has a closed configuration, such that the first beam contacts the second beam, and an open configuration, such that the first beam is separated from the second beam.

In some embodiments, the first arm has a first rotational configuration, such that the first pivot point is positioned over the first fluid bath and the first beam and the second beam are within the first fluid bath, and a second rotational configuration, such that the first pivot point is positioned over the second fluid bath and the first beam and the second beam are within the second fluid bath.

In some embodiments, the first beam and the second beam are biased to contact each other.

In some embodiments, the first bar extends from the first pivot point away from the first beam to a first clasp and the second bar extends from the first pivot point away from the second beam to a second clasp. In some embodiments, the system further comprises a biasing member connecting the first clasp to the second clasp. In some embodiments, the biasing member comprises an elastic material.

In some embodiments, the second fluid bath comprises a rigid separator configured to separate the first beam from the second beam while the transfer assembly is at least partially in the second fluid bath.

In some embodiments, the transfer assembly is freely rotatable about the first pivot point, such that the first beam and the second beam are configured to remain vertically below the first pivot point as the first arm rotates about the pivot axis.

In some embodiments, each of the first beam and the second beam comprises a plurality of dimples configured to cradle the payload. In some embodiments, each of the dimples of the first beam is adjacent to a corresponding one of the dimples of the second beam when the first beam is in contact with the second beam.

In some embodiments, the first arm is orthogonal to the pivot axis.

In some embodiments, the system further comprises: a second arm extending from the pivot axis to a second pivot point, the second arm being rotatable about the pivot axis; wherein the transfer assembly is further attached to the second arm at the second pivot point, the transfer assembly being further rotatable about the second pivot point, and the transfer assembly further comprising (i) a third bar extending from the second pivot point to the first beam and (ii) a fourth bar extending from the second pivot point to the second beam.

In some embodiments, the pivot axis is between the first fluid bath and the second fluid bath.

In some embodiments, a method for transferring a payload between fluid baths, comprises: receiving the payload in a first fluid bath and between a first beam and a second beam of a transfer assembly, while the first beam and the second beam contact each other in a closed configuration; transferring the payload from the first fluid bath to a second fluid bath while the first beam and the second beam maintain the closed configuration; and releasing the payload from the first beam and the second beam by separating the first beam and the second beam in an open configuration.

In some embodiments, the transferring comprises: rotating an arm about a pivot axis, such that the transfer assembly, attached to the arm at a pivot point a distance from the pivot axis, freely rotates about the pivot point.

In some embodiments, the transferring further comprises: maintaining the first beam and the second beam vertically below the pivot point.

In some embodiments, the receiving comprises cradling the payload across a dimple of the first beam and a dimple of the second beam.

In some embodiments, the releasing comprises bringing the transfer assembly in contact with a rigid separator, such that the first beam is on a first side of the rigid separator and the second beam is on a second side of the rigid separator.

In some embodiments, the receiving comprises coating the payload with a substance of the first fluid bath.

In some embodiments, the transferring comprises coating the payload with a substance of the second fluid bath.

The details of one or more embodiments of the invention are set forth in the accompanying drawings and the description below. Other aspects, features, and advantages of the invention will be apparent from the description and drawings, and from the claims.

### DESCRIPTION OF DRAWINGS

FIG. 1 is a front view of an examplary machine for producing natural transport systems.

FIG. 2 shows the chemical structure of an alginate polymer-(M)ₘ-(G)ₙ-(M: mannuronate; G: guluronate).

FIG. 3 illustrates polymerization of sodium alginates via divalent cations (e.g., Ca²⁺).

FIG. 4 illustrates a vessel in which liquid water is embedded in a fine jelly membrane of alginates.

FIG. 5A illustrates a process to create the vessel of FIG. 4.

FIG. 5B illustrates vessels created using the process of FIG. 5A.

FIG. 6 is a perspective view of the machine of FIG. 1.

FIG. 7 is a side view of the machine of FIG. 1.

FIG. 8 is a top view of the machine of FIG. 1.

FIG. 9 is a perspective view of the machine of FIG. 1 with its cover open.

FIG. 10 is a view of the extrusion system of the machine of FIG. 1.

FIGS. 11A and 11B illustrate reservoirs of the example machine of FIG. 1.

FIG. 11C is a cross-sectional view of the machine of FIG. 1.

FIGS. 12A and 12B are side views of the machine of FIG. 1.

FIG. 13 is an enlarged view of a receptacle that can be used in the machine of FIG. 1.

FIG. 14 is a cross-sectional view of a portion of an embodiment of an extrusion outlet.

FIG. 15 illustrates a guide channel of the machine of FIG. 1.

FIG. 16 illustrates a perforated tray of the machine of FIG. 1.

FIG. 17 illustrates a removable insert perforated tray of the machine of FIG. 1.

FIG. 18 shows a fluid vessel including a fluid-displacing liquid insert of FIG. 1.

FIG. 19 shows a perspective view of a system for transporting a payload.

FIGS. 20A, 20B, 20C, and 20D shows sectional views of a system for transporting a payload.

FIG. 21A shows a front view of an arm.

FIG. 21B shows a side view of an arm.

FIG. 21C shows a perspective view of an arm.

FIG. 22A shows a front view of a bar.

FIG. 22B shows a side view of a bar.

FIG. 22C shows a perspective view of a bar.

### DETAILED DESCRIPTION

Systems used to transport substances (e.g., consumable substances such as foods, drinks, medicines, etc.) can include containers (e.g., edible containers). The containers can be single or multi-layer containers (e.g., 1, 2, 3, 4, etc. layers). The containers can be formed of substances of substances (e.g., consumable substances) conducive to transportation and consumption. Layer(s) of the containers can be edible providing benefits (e.g., nutritional benefits, etc.) as well as reducing concerns about, for example, littering, solid waste management, etc.

Embodiments of our systems can be manufactured forming a container (e.g., a shell, etc.) around a volume (e.g., a serving) of a substance (e.g., a consumable substance such as a food, drink, medicine, etc.). In some cases, the container is formed around a volume of a substance or substances (e.g., solid, semi-solid, liquid substance(s)). The consumable substance may be solid at room temperature or the volume may be treated (e.g., to heat, to chill, to freeze, etc.). In some cases, the container contains a volume (e.g. a serving) of a liquid substance (e.g., a liquid consumable substance, etc.).

The container can include a layer formed by a membrane forming solution(s) such as, for example, alginate, chitosan, gellan gum, etc., activated by contacting the membrane forming solution with an activating agent such as, for example, a divalent or trivalent metal solution (e.g., calcium, magnesium, etc.). In some cases, the volume of the substance (referred to in some instances as the payload) can act as an activating agent, e.g. when contacted by the membrane forming solution(s). Transport systems can have, e.g., varying shell or membrane thickness, chemistry, varying numbers of shells or membranes, multiple internal content materials, various shapes, and various shell/membrane properties including taste and resistance. The membrane forming solution(s), the activating agent, container components, etc., may be applied using a fluid vessel, a spray, vapor deposition, etc. For example, a serving of orange juice can be frozen in a desired shape and then processed to form a membrane around the orange juice. The frozen orange juice can be submerged into a bath containing divalent ions (e.g., Ca²⁺ or Mg²⁺) to form a first layer (e.g., coating) of metal ions allowing the start of formation of a membrane around the orange juice, and then into a liquid nitrogen bath. The coated orange juice then can be submerged into a polymer (e.g., alginate) bath to further form a membrane around the coated orange juice, and then into a solution (e.g., calcium chloride solution) which solidifies the membrane and orange juice in an edible container. The application of divalent cations twice, with the application of the polymer in between, allows for the membrane to harden both from within and without. The frozen orange juice inside the edible container can then be allowed to melt.

Transport systems can be made using various scale production systems including, for example, production systems configured to produce single transport systems (e.g., for home use), production systems sized and configured to produce multiple transport systems (e.g., for use in a retail setting), and production systems configured to produce large quantities of transport systems (e.g., for use in industrial production). Such production systems can include processes and technologies such as, for example, extrusion, spray drying, fluidized-bed, etc. Several production systems are described below. Other production systems are described in WO 2011/103594 filed Feb. 22, 2011 which is incorporated herein by reference in its entirety. Other production systems can be implemented by varying the scaling and the incorporated processes of the described production systems.

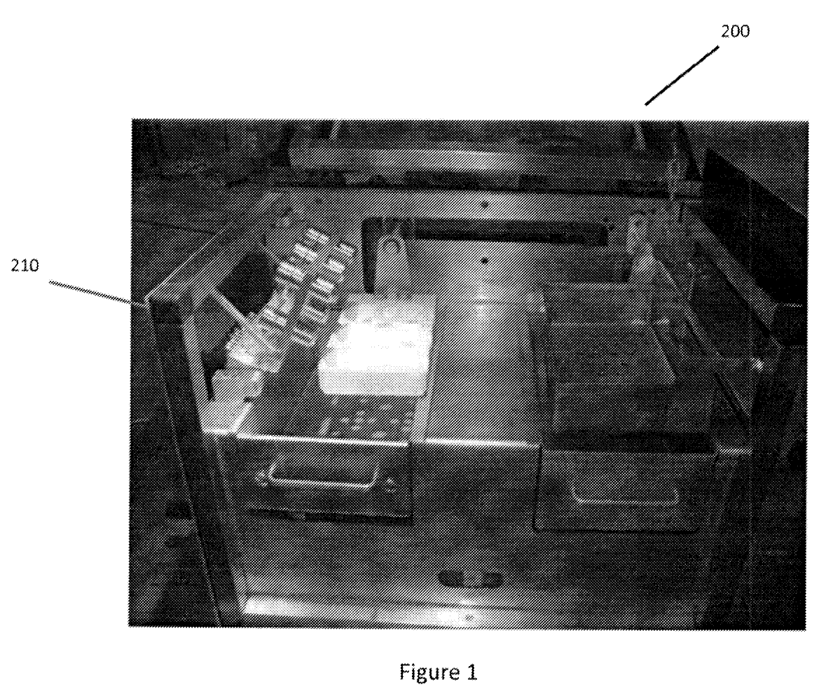

Referring to FIG. 1, an exemplary system for manufacturing transport systems includes a plurality of stations for sequentially receiving, transferring, and processing a consumable flowable substance. The receiving, transferring and processing encapsulate the consumable flowable substance in at least one edible or biodegradable membrane. This system includes a first station receiving the consumable substance from at least one inlet, wherein the substance is contacted with at least one component of the edible or biodegradable membrane; a second station receiving the substance from the first station; and a transfer mechanism to transfer the substance between the first station and the second station. The transfer mechanisms transfer an object (e.g., a frozen serving of a consumable liquid, e.g., orange juice, etc.; a solid object, e.g., a cheese, etc.) between the different processing stations to produce the transport system. The machine includes two processing stations and a movable receptacle. The movable receptacle transfers an object between the two processing stations to produce the transport system. The system 200 has a frame 210 that supports components of the machine including individual processing stations.

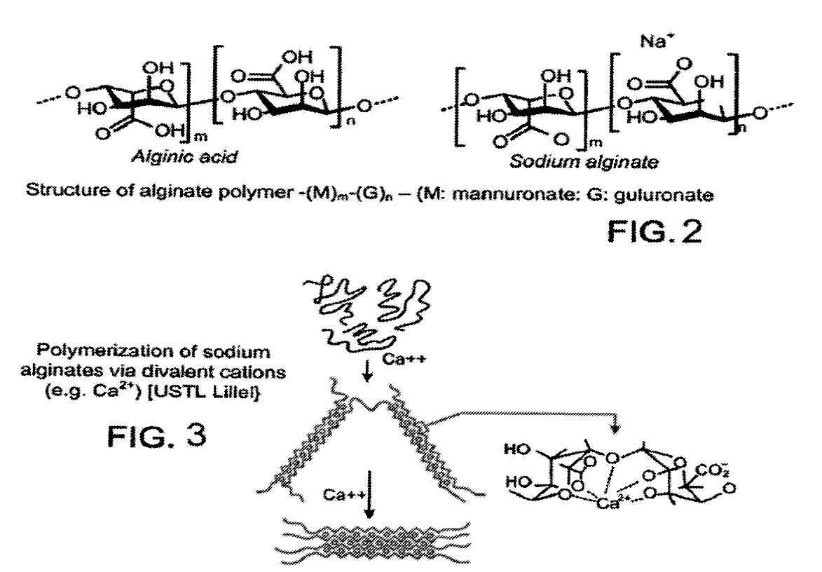

Referring to FIG. 2, alginate (alginic acid) is an example of polymer that can be used in forming transport systems. Alginate is an anionic polysaccharide, widely present in the cell walls of brown algae. It is a copolymer -(M)ₘ-(G)ₙ-, composed by mannuronate M (manurronic acid) and guluronate G (guluronic acid) monomers respectively (see FIG. 2). The values of m and n, the ratio m/n, and the space distribution between M and G (i.e., presence of consecutive G-blocks and M-blocks, or randomly organized blocks) all play key roles in the chemical and physical properties of the final copolymer.

Alginates are used in various applications, such as pharmaceutical preparations, impression-making materials (e.g., in dentistry and in prosthetics manufacturing), and in the food industry. Gelation can be induced by electrostatic cross-linking by removing the naturally bound Na⁺ ion and replacing with divalent cations, e.g., Ca²⁺ or another multi-valent cation such as Mg²⁺ (see FIG. 3). Beyond their capability to easily form a gel, and their biocompatibility, alginates are also used for cell immobilization and encapsulation.

In recent years, sodium alginates have found application in restaurants, e.g., to create spheres of liquid surrounded by a thin jelly membrane. Modern chefs have created “melon caviar,” “false fish eggs”, etc. by adding sodium alginates into a liquid (e.g., melon juice), then dropping the preparation in a calcium bath (calcium lactate or calcium chloride). However, parameters for manufacturing these alginate spheres remain difficult to optimize or control, including: (i) the size of the spheres; and (ii) the texture of the liquid embedded in the membrane. Manufacturing larger sized spheres has remained a challenge since, in known methods, the liquid falls in the calcium bath from a syringe or a straw and alginate solution surface tension limits the size of the sphere. In terms of texture, increased alginate concentration significantly increases the viscosity of the liquid. The increased viscosity can be required to stabilize and to form the jelly membrane more easily. However, an alginate sphere made from a solution of greater viscosity is often unpleasant while tasting and/or consuming the liquid, and may also mask aromas of the liquid.

As discussed above, other forming agents such as, for example, chitosan, gellan gum, etc. can be used to form transport systems. The general approach described herein involves a new kind of encapsulated vessel that uses materials both known and newly conceived to provide macroscopic vessels. These vessels are sufficient for material transport, having the properties of strength, stability, and biodegradability necessary to transport water and other materials as done with bottles, buckets, glasses and other classical vessels. Examples to reduce our concept to practice are provided herein.

### EXAMPLE 1

### Preparation of a Stable and Mechanically Robust Alginate Shell for Liquid Encapsulation

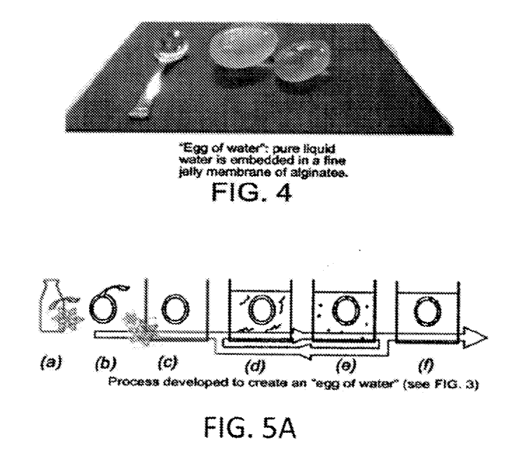

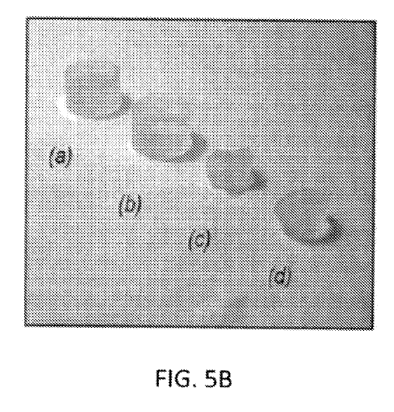

As shown in FIG. 4, we obtained an “egg of water” (water was used as a reference liquid, but other liquids can also be used), by following the method summarized in FIG. 5A including the following steps:

(a) The liquid was frozen in the desired form (e.g., by a person, by an external process or system). This step may not be necessary when a solid or semi-solid object is being covered.

(b) The object was then submerged into a bath of an activating agent at a first processing station. A calcium solution (e.g., calcium chloride solution) was used as the activating agent in the test. However, other activating agents such as, for example, a divalent or trivalent metal solution (e.g., calcium, magnesium, etc.) can also be used. Submerging the object into the calcium solution provided a calcium layer on the object that produced a higher quality membrane layer. In some embodiments, a greater submersion time in the calcium solution will create a thicker membrane on the object.

(c) At a second processing station, the object is then further cooled in a temperature reducing agent. Liquid nitrogen was used as the temperature reducing agent in the test. However, other temperature reducing agents such as, for example, other liquefied gases, etc. can be used as the temperature reducing agent. This station and step are optional. Some systems and methods are implemented without this cooling step.

(d) At a third processing station, the solid from step (c) is placed in a layer forming solution. A sodium alginate solution was used as the layer forming solution in the test. However, other layer forming materials, such as, for example, alginate, chitosan, gellan gum, etc. can be used as the layer forming solution. As the solid was very cold, alginates froze on the surface. Thus, the thickness of the final jelly membrane was readily tunable. For example, a greater submersion time in the alginates will generally create a thicker membrane on the solid.

Moreover, the liquid nitrogen induced a “dried and cold” surface after the step (c) to which the alginates adhered easily. Through our experiments, we discovered that the step (c) provides particularly improved results: in the case of the process of step (a) directly to step (d) (skipping steps (b) and (c)), the solid in contact with the alginate solution at room temperature (approximately 20° C.) melts quickly on the solid surface, thus creating a liquid film between the solid and the alginate solution. Consequently, it is very difficult to stabilize a homogeneous membrane.

(e) After the desired time ended to achieve the desired thickness of the membrane, the membrane-covered solid is moved to a fourth processing station 108 and is placed in an activating agent. A calcium solution (e.g., calcium chloride solution) was used as the activating agent in the test. However, other activating agents such as, for example, a divalent or trivalent metal solution (e.g., calcium, magnesium, etc.) can also be used

Optionally the steps of placing the coated solid (e.g., the calcium-coated solid) in the layer forming solution (e.g., the alginates) and then placing the membrane-covered solid in the activating agent (e.g., calcium) (step (d) and step (e)) can be repeated to produce a thicker, harder, and more rigid shell, with or without the other steps (e.g. additional cooling in liquid nitrogen).

(f) The membrane covered solid is rinsed (e.g., in water). The liquid within the coated membrane was allowed to melt gradually.

### EXAMPLE 2

### Machine for Preparation of a Stable and Mechanically Robust Shell for Encapsulation of Edible Substances

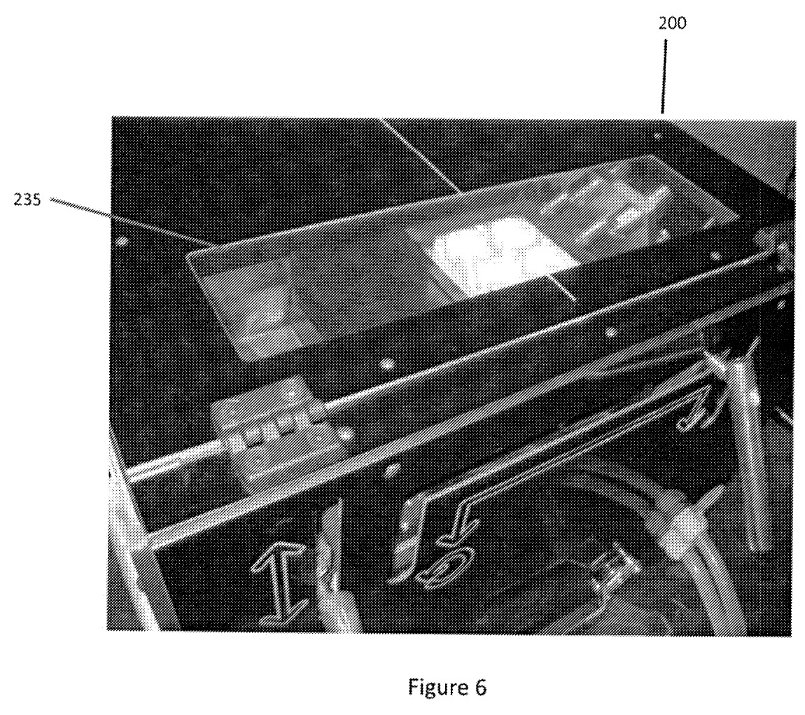

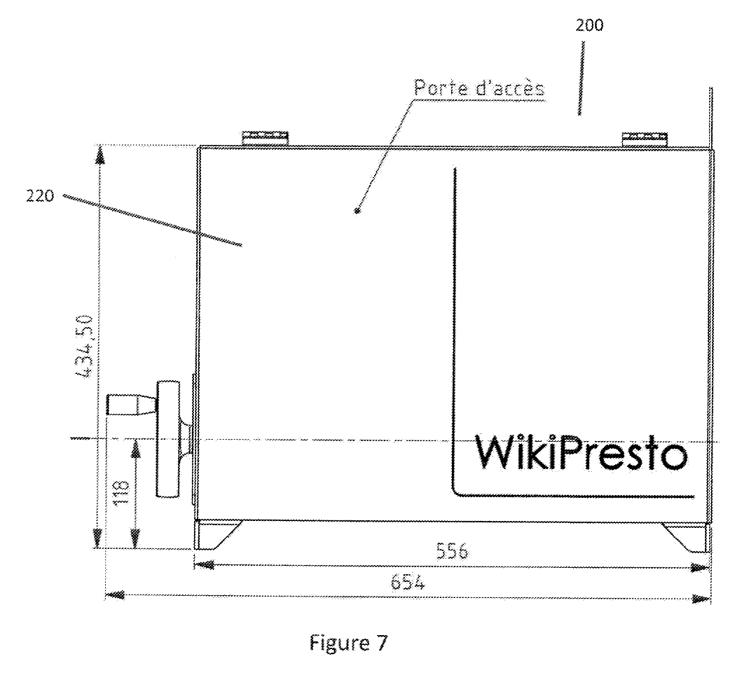

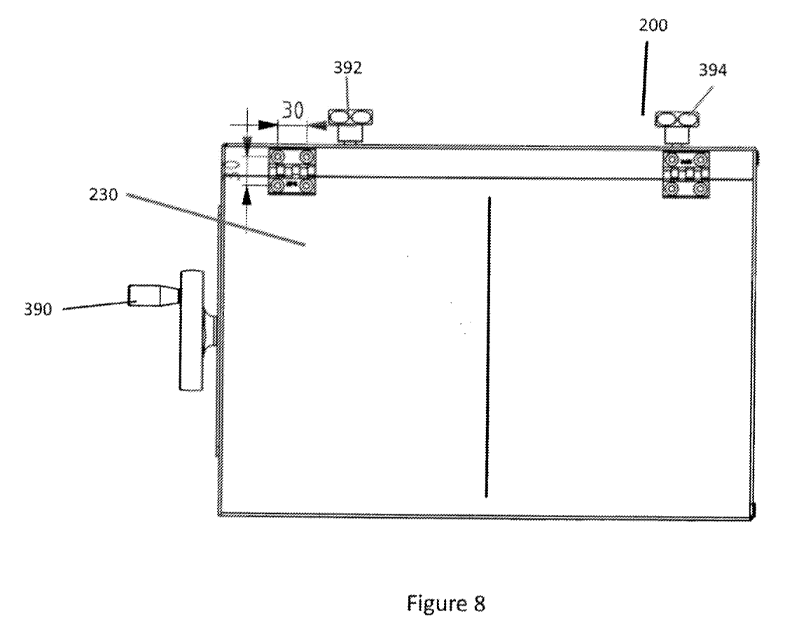

Referring again to FIG. 1, the machine 200 has a frame 210 that supports components of the machine including individual processing stations. Machine 200 has a removable front cover 220 (FIG. 7) and a removable top cover 230 (FIG. 8) which may contain a window 235 to make the interior of the machine 200 at least partially visible (FIG. 6).

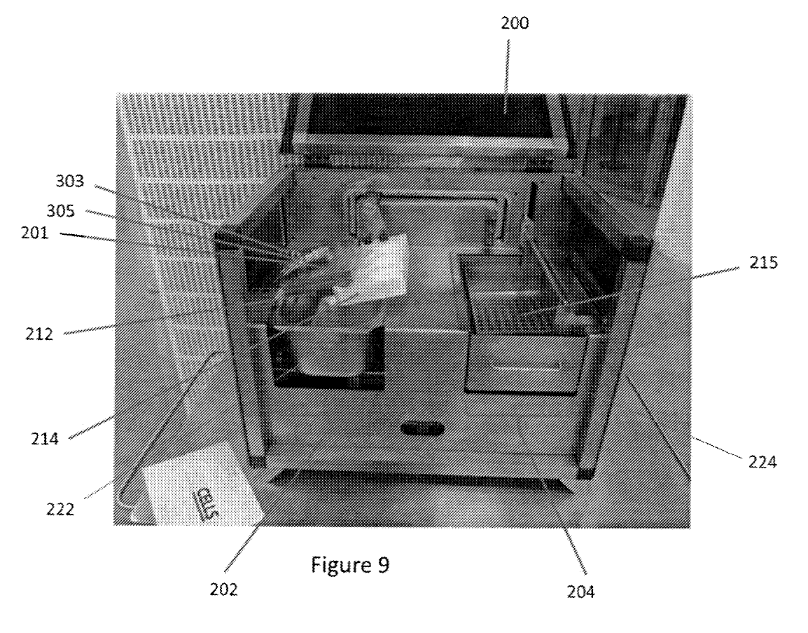

Referring to FIG. 9, machine 200 has an extrusion apparatus 201 including one or more extrusion outlets 212, a receptacle 214, a first processing station 202, a second processing station 204, and a removal mechanism including a perforated tray 215 for removal of coated substances.

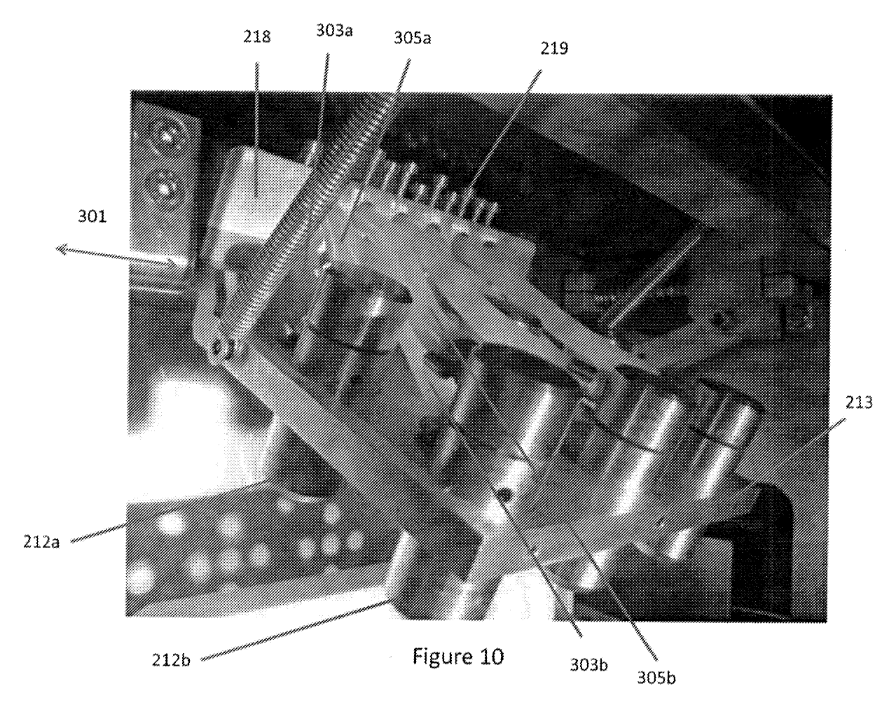

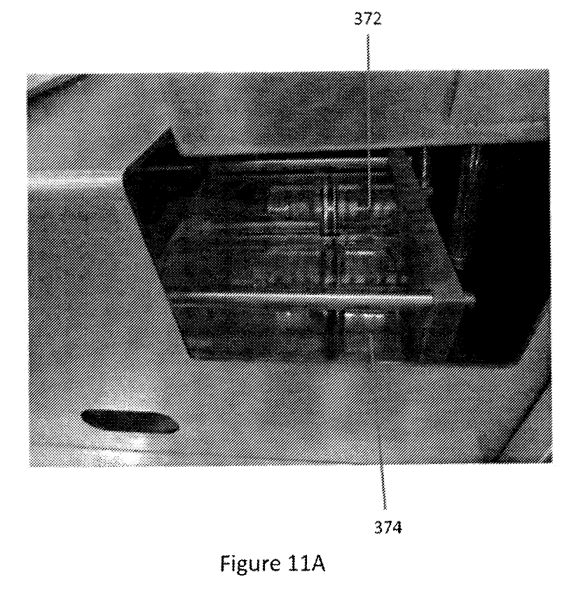

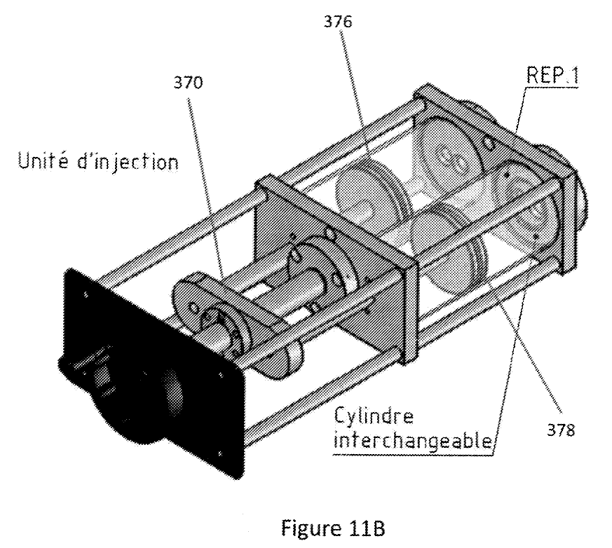

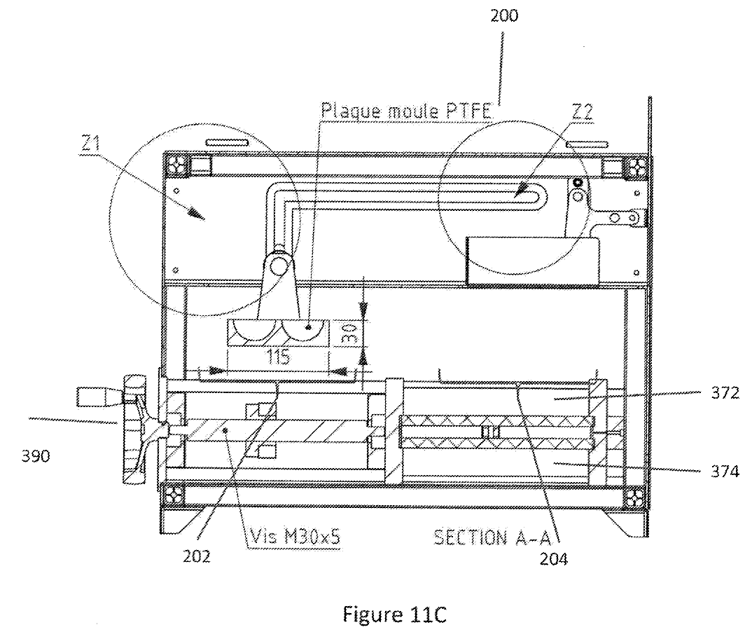

Referring to FIGS. 11A and 11B, extrusion apparatus 201 includes a supply pump 370 connected to two reservoirs 372 and 374. Reservoirs 372 and 374 are easily removed from the extrusion apparatus, replenished, or replaced by new reservoirs either manually or using automation. Each reservoir 372 and 374 is respectively coupled to a piston 376 and 378 that controls movement of substances in and out the tanks, and conduits 303 and 305 (shown in FIG. 10), which are coupled to extrusion outlets 212. As shown in FIG. 11C, reservoirs are located under the first and second processing stations 202 and 204. However, the reservoirs can be located inside or outside of machine 200. In this system, the pistons are moved manually (e.g., using a hand crank 390). In some systems, the pistons are moved by an automated system including a controller. In some embodiments, extrusion apparatus 201 can include one, two, three, four, or more reservoirs. In some embodiments, an external source (rather than internal reservoirs) provides the material being coated, the coating material, etc. For example, an external reservoir could be connected to one or more machines 200.

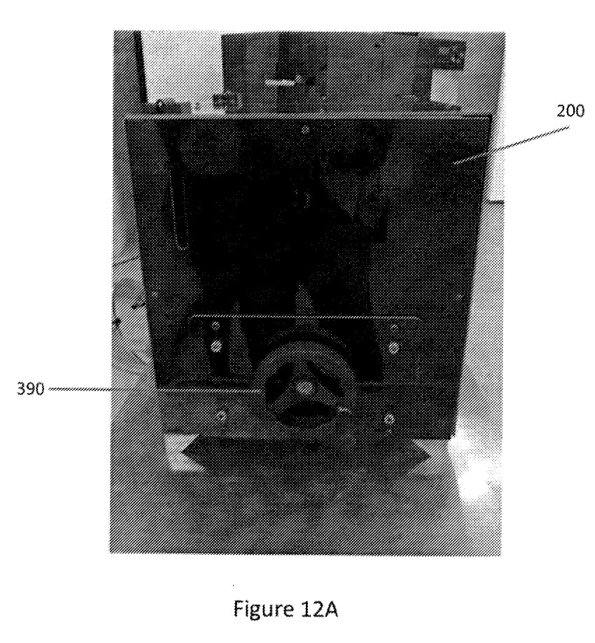

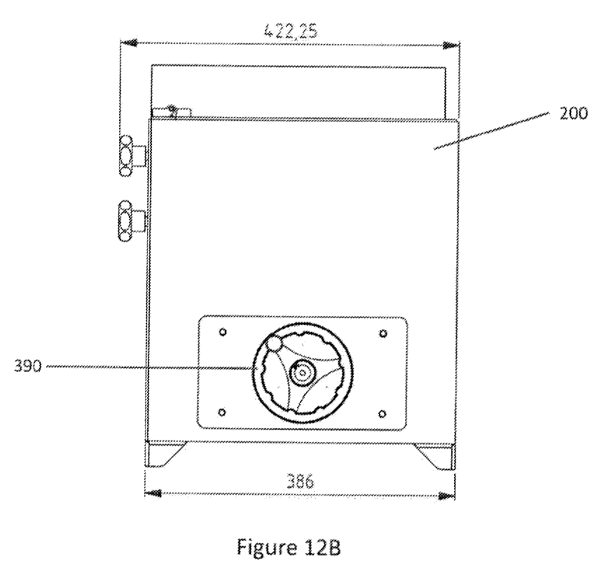

Referring to FIGS. 12A and 12B, a crank 390 draws substances into reservoirs 372 and 374 when rotated in a counter-clockwise direction. Extrusion of substances from reservoirs 372 and 372 is caused by rotating crank 390 in an opposite direction, e.g., a clockwise direction. Once a desired volume of a given substance is dispensed, reservoirs 372 and 374 are replaced or replenished with the same or a different substance. Reservoirs 372 and 374 can have different volumes. For example, reservoirs 372 and 374 can each independently have a size of 1000 mL or greater and/or 4000 mL or less.

Referring to FIGS. 9 and 10, the extrusion apparatus includes six extrusion outlets 212 forming an array on a substrate 213, which is movable relative to receptacle 214. In this embodiment, the substrate rotates about an axis 301, such that the extrusion outlets are lowered or raised relative to receptacle 214. The extrusion outlets 212 are configured to dispense a substance (e.g., a consumable substance) or substances into receptacle 214. In some embodiments, extrusion outlets 212 are configured to translationally oscillate relative to the first fluid vessel as the substance(s) are dispensed.

The distance between the extrusion outlets 212 and an uppermost surface of receptacle 214 is adjustable. For example, the distance can range from below the surface to about 0 cm (e.g., 3 cm, 5 cm, 7 cm, or 9 cm) to about 10 cm (e.g., 9 cm, 7 cm, 5 cm, 3 cm). The extrusion outlets 212 are connected to conduits 303 and 305 (shown in FIG. 9), which are in turn connected to reservoirs 372 and 374. The conduits can be, for example, substance delivery hoses, lines or pipes connecting a supply reservoir to the nozzle. In some embodiments, the reservoirs (e.g., internal reservoirs 372, 374, etc.) are pressurized. Such systems can regulate discharge of material from the reservoirs using valves rather than by controlling pumps.

Conduits 303 and 305 can deliver substances directly to the extrusion outlets 212 or can be divided to deliver separate flows to each extrusion outlet 212. Referring to FIG. 10, in some embodiments, conduit 303 delivers a substance to individual conduits 303a, 303b, etc., where each individual conduit is connected to a different extrusion outlet 212 (e.g., 212a, 212b, etc.). Conduit 305, carrying the same or a different substance than conduit 303, flows into separate individual conduits 305a, 305b, etc., each likewise connected to an extrusion outlet 212. Each extrusion port has two individual conduits delivering substance to it, although more than two individual conduits are also possible. The connection between conduits 303, 305 and individual conduits 303a, 303b, 305a, 305b, etc., can take place at any point upstream of the point where the substance is delivered to the extrusion outlets 212.

In general, the shorter the conduits 303 and 305 are, the less substance is wasted during extrusion. In some embodiments, an entirety of the extrusion apparatus, or parts thereof (e.g., conduit 303 and 305, individual conduits 303a, 305a, etc., extrusion pumps, and/or extrusion outlets 212), can be refrigerated, or warmed. The conduits may be coated with materials to impede or enhance flowability of substances. For example, the conduits can be coated, for example, with PTFE, etc. In other embodiments the hoses pipes or lines can be electrically charged to be the same, neutral, or opposite that of the substances flowing through the delivery vessels.

In some embodiments, extrusion apparatus 201 has multiple extrusion outlets 212 (e.g., two outlets, three outlets, four outlets, five outlets, six outlets, or more), which are connected to a single or double extrusion pump via conduit 303 and 305, or individual conduits 303a, 305a, etc. In some embodiments, the extrusion outlets 212 are connected to more than two extrusion pumps via multiple conduits (e.g., one conduit per pump). In some embodiments, multiple pumps can be actuated differentially for volume and flow rate and activated for different nozzles or different extrusion ports of concentrically disposed nozzles. In some embodiments, the flow rate of each delivery tube can be individually modified downstream of the pump. FIG. 10 shows the substrate 213 of the extrusion apparatus 201 includes a tube mount 218. Individual conduits 303a, 305a, etc., are passed through holes on tube mount 218 that are suitably sized to receive the individual conduits. Flow modifying mechanism 219 can be individually controlled to independently modify the flow rate of each individual conduit. The flow modifying mechanism 219 can be a screw which constricts individual conduits 303a, 305a, etc. Alternatively, flow modifying mechanism 219 can be a valve that partially or completely blocks the flow. Flow modifying mechanism(s) can be manually or automatically controlled.

The extrusion outlets can be spaced apart by varying distances, which can be tailored depending on the spacing of receiving cells in receptacle 214. In certain aspects, the extrusion port nozzles are oriented in a downwards position, over a fluid vessel or in fluid communication with a fluid vessel. In other aspects, the nozzles can be located at the bottom of a station receptacle, for example a receptacle containing a fluid vessel, pointing in an upwards orientation. Examples of outlet (e.g., nozzles) with an upwards orientation are described in in WO 2011/103594 filed Feb. 22, 2011 which is incorporated herein by reference in its entirety.

In some embodiments, the different sizes and shapes of extrusion outlets 212 are used. For example, the extrusion outlets 212 can extrude a flow of substance having a diameter of about 2 to 8 cm. In some embodiments, the extrusion outlets 212 extrude a flow of substance having a cross section that is circular, elliptical, star-shaped, square, diamond-shaped, or irregularly shaped. In some embodiments, the size and shape of the extrusion outlets 212 are adjustable.

In some embodiments, the extrusion outlet may oscillate with a controllable horizontally linear and/or circular area displacement and rate relative to a stationary receptacle 214, such that a dispensed substance takes on a shape of a helix, similar to that of soft serve ice cream. In this configuration, layers of different materials extended internally within the transport system, being formed. It is hypothesized that, with some materials, this configuration can provide additionally structural stability to the transport system. In other aspects, the receptacle may oscillate with a controllable horizontally linear and/or circular area displacement and rate relative to a stationary extrusion nozzle. In still other embodiments, concentrically disposed extrusion nozzles may have muzzles of the nozzles oriented on the same plane or different planes. The extrusion outlets can be synchronously or independently operated, at different or similar volume and flow rates, and in fluid communication with independent pumps or mutual pumps and related actuated mechanisms (for example fluid pump pistons).

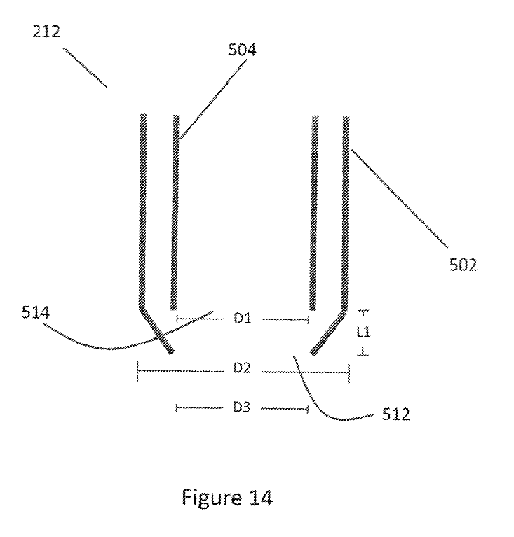

In some embodiments, an extrusion outlet 212 has more than one opening, such that the substance is extruded in multiple streams toward a given cell in receptacle 214. As an example, referring to FIG. 14, an extrusion outlet can include two concentric tubes 502 and 504, where an outer tube 502 surrounds an inner tube 504. Inner tube 504 has an inner opening 514 having an inside diameter D1. Outer tube 502 has an outer opening 512 having an inside diameter D3. As shown in FIG. 14, D1 and D3 are identical. However, in some embodiments, D3 is larger than D1. As shown in FIG. 14, outer opening 512 has a lower position relative to inner opening 514, defined by distance L1. When outer tube 502 has tapered opening 512, distance L1 can range from greater than 0 mm to 50 mm. In some embodiments, outer tube 502 can have an opening that does not taper, such that D3 is greater than D1 and distance L1 ranges from 0 mm to 50 mm. In some embodiments, the concentric tubes and/or openings have different shapes. For example, an outer opening can have a star shape, while the inner opening can have a circular shape. In other embodiments, the extrusion port muzzles of concentrically located extrusion ports in an extrusion opening are located in the same plane or at least one extrusion port muzzle is located above the plane or below a plane defined by at least one other extrusion port muzzle. In other embodiments the extrusion nozzles are electrically charged, having a charge pole opposite that of a receptacle into which substances are disposed by the extrusion nozzle.

When extrusion outlet(s) 212 has (have) more than one opening (e.g., two concentric openings), the openings can each dispense different materials. For example, two openings can dispense two different edible or potable substances. As another example, one opening (e.g., the inner opening) can dispense a consumable (e.g., an edible or potable substance), while another opening (e.g., the outer opening) can dispense a membrane-forming material.

In some embodiments, one or more extrusion outlets 212 are used in combination with a carbonation system, such that an exit stream is infused with a gas (e.g., carbon dioxide).

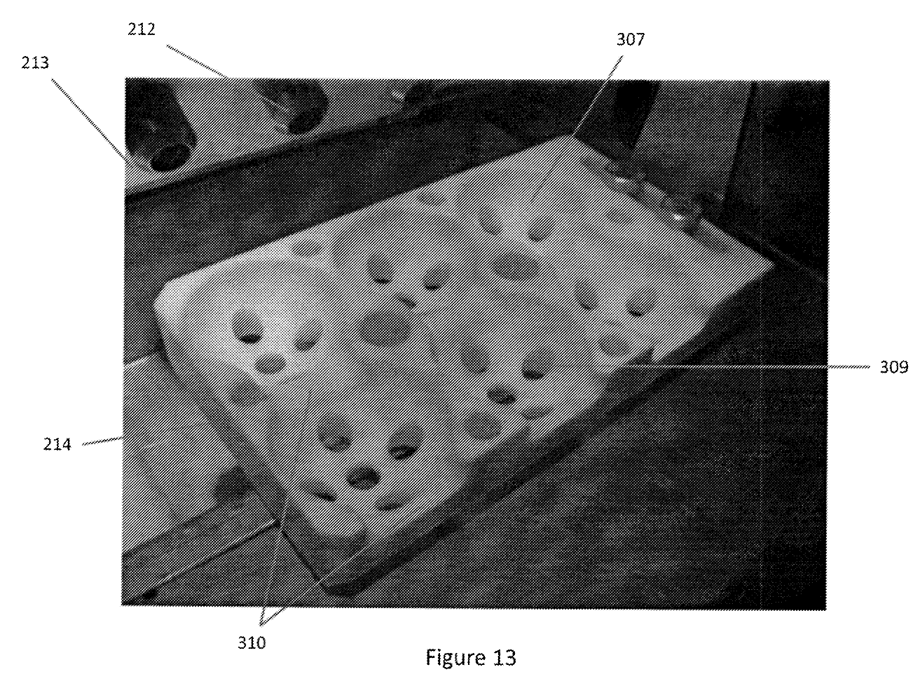

Referring to FIG. 13, receptacle 214 has six hemispherical cells 307 for receiving the substance from extrusion outlets 212. A receptacle can have 1, 2, 3, 4, 5, 6, 7, 8 ,9, 10 or more cells. Cells 307 can have other shapes (e.g., pyramidal, ovoid, cubic, etc.), although it is desirable that the edges of the cells are curved or beveled and devoid of sharp edges. Cells 307 may not be complete hemispheres. Notches 310 can reduce the height of parts of the circumferential edge of cells 307, facilitating removal of substances from the cells. Notches 310 can have the same or different heights and widths, i.e., can remove different surface areas from the sides of cells 307.

Cells 307 can range in volume. For example, cell 307 can have a volume of 3 mL or greater (e.g., 10 mL or greater, 50 mL or greater, 100 mL or greater, 150 mL or greater, or 200 mL or greater) and/or 250 mL or less (e.g., 200 mL or less, 150 mL or less, 100 mL or less, 50 mL or less, or 10 mL or less). In some embodiments, receptacle 214 and/or cell 307 can have a removable bottom portion, or a bottom portion that can open. Receptacle 214 can be made of polytetrafluoroethylene (PTFE), which provides a non-stick surface for the contents of the receptacle. In some embodiments, receptacle 214 is made of other materials of food grade quality, including but not limited to aluminum, stainless steel and other food grade plastics, although it is desirable that the material can allow for smooth delivery of the contents from the receptacle.

As shown in FIG. 13, receptacle 214 has openings 309, which drain excess fluid from as well as decrease the weight of receptacle 214. Openings 309 can each independently have the same or different shapes and/or sizes. Openings 309 can be located on a top surface of the receptacle 214 as well as in each cell 307 to allow fluid to drain from both the top of the receptacle and each cell 307.

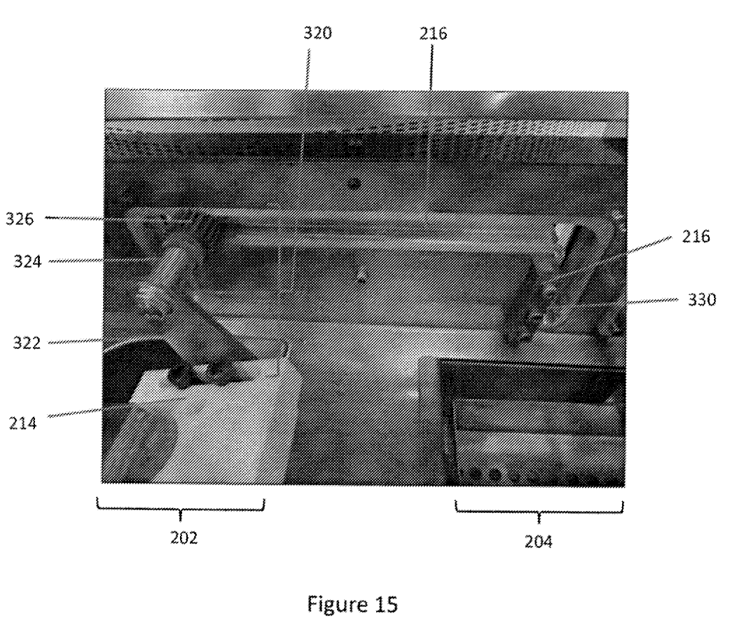

In operation, receptacle 214 travels from the first processing station 202 to the second processing station 204, and vice versa, via a guide channel 216. Referring to FIG. 15, receptacle 214 is connected to a rotatable mechanism 320. Rotatable mechanism 320 has an arm 322 and a rotatable joint 324 coupled on one end to arm 322. The rotatable joint 325 is also coupled at an opposite end to guide channel 216. Rotatable joint 324 includes cogs 326 that engage a channel 328 including teeth 330 near the second processing station 204, such that receptacle 214 rotates to pour a coated substance into second processing station 204 when receptacle 214 is moved down the length of channel 328 of teeth 330 toward second station 204. Guide channel 216 extends from first processing station 202 to second processing station. Guide channel 216 provides a channel for engaging rotatable joint 324, which glides along guide channel between first processing station 202 and second processing station 204. Movement of receptacle 214 can occur manually or automatically. Referring back to FIG. 9, the first processing station 202 has a fluid vessel 222, which is a reservoir filled with a liquid to coat a substance when the substance contacts the liquid in receptacle 214. The fluid vessel 222 is made of materials suitable to contain fluid (e.g., stainless steel, plastic) and is sized to permit submersion of receptacle 214 and its contents. Fluid vessel 222 can be adjusted in dimension and volume. For example, the fluid vessel 222 can have a volume of about 1 L or greater and/or about 10 L or smaller. The fluid vessel may further comprise a voltage differential for increasing ion flow out of the consumable substance (e.g., calcium ions). The fluid vessel 222 is easily exchangeable with another fluid vessel (e.g., another fluid vessel containing a different fluid, etc.) either manually or automatically. The distance between the first processing station 202 and the extrusion outlets 212 can be varied, for example, by rotating the extrusion outlets about axis 301. In some embodiments, the fluid vessel 222 can be warmed or cooled using a warming or cooling apparatus.

Referring back to FIG. 9, second processing station 204 includes a fluid vessel 224, which is a reservoir filled with a liquid to treat a coated substance when the coated substance is submerged in the liquid. The fluid vessel 224 is made of materials suitable to contain fluid (e.g., stainless steel, plastic) and is sized to permit submersion of the coated substance. The fluid vessel 224 can have various dimensions and volumes. For example, the fluid vessel 224 can have a volume of about 1 L or greater and/or about 4 L or smaller. The fluid vessel 224 is easily exchangeable with another fluid vessel (e.g., another fluid vessel containing a different fluid) either manually or automatically. In some embodiments, the fluid vessel 224 can be warmed or cooled using a warming or cooling apparatus.

In some embodiments, fluid vessel 224 can have a continuous or intermittent flow of liquid into and out of the vessel, such that the volume of the fluid within fluid vessel 224 remains substantially constant (e.g., within 90% of starting volume, within 95% of a starting volume, or within 99% of a starting volume) during coating processes. In some embodiments, a processing station also includes a filtration system to remove macroscopic insoluble particles from individual or a plurality of fluid vessels, for example vessel 224. A filter(s) (e.g., a cartridge filter, a membrane filter, etc.) can be installed in fluid communication with (e.g., at the inlet of, at the outlet of, etc.) the vessel 224. For example, the fluid vessel 224 (or other fluid vessels in the system) can be configured with flow recycling loop that both receives fluid from and discharges fluid to the vessel 224. A filter installed in such a flow recycling loop can remove loose particles formed by interaction between activating agent and membrane forming agent and can extend the time between replacement of fluid in the vessel.

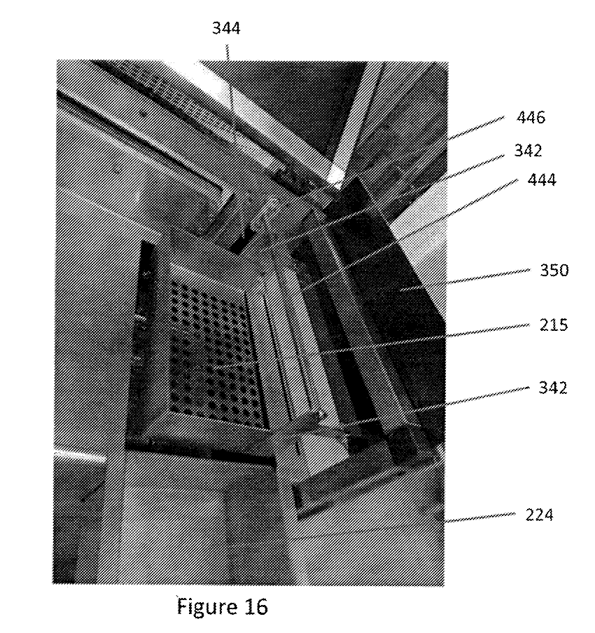

Referring to FIG. 16, machine 200 includes a removal mechanism 215 that removes the coated substance from fluid vessel 224. Removal mechanism 215 is a perforated tray, such that excess fluid can drain from the coated substance back into fluid vessel 224. The perforations have smooth edges to avoid puncturing the coated substance. The perforations can have varied sizes and shapes, so long as they can allow fluids and small particles to drain but retain the coated substance, without puncturing the coated substance.

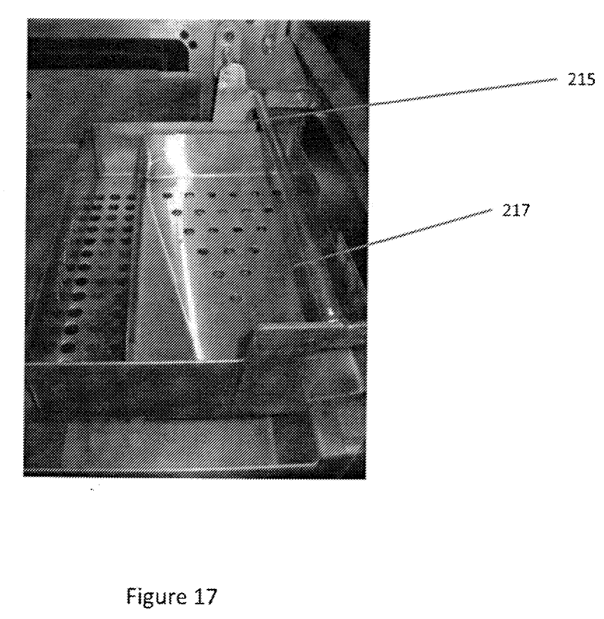

In the illustrated embodiment, the perforated tray is generally horizontal and operators use a utensil such as a spatula to remove coated products from the device. In some embodiments, other removal mechanisms can be used. For example, FIG. 17 illustrates a perforated second tray 217 nested within removal mechanism 215. Perforated second tray 217 is removable from the first tray 215, and an operator can remove all coated products from the second station 204 simultaneously by removing the second tray 217. The second tray may simply be placed inside the first tray and held together by gravity, or may have some easily detachable connection mechanism to temporarily connect the two trays while they are lowered into the fluid vessel. This connection mechanism may be a clip or other fastener such as snap-fit matching male and female portions of the trays. Second tray 217 can include a handle, which may be thermally insulated. The handle can be permanently attached to second tray 217, or may be a separate device such as tongs. The second perforated tray 217 can contain holes that are the same size, or different than those in 215.

In some embodiments, the bottom of the removal mechanism can be angled to bias coated products to move towards the system outlet when the removal mechanism lifts the coated products from the fluid vessel 224. This slanted bottom can be present on either or both of removal mechanism 215 or second tray 217. In some embodiments, the bottom member of the removal mechanism is rotatable (e.g., about a hinge, etc.) such that the inclination of the bottom member of the removal mechanism can be varied. For example, the angle of inclination can be increased when an object(s) is (are) being discharged from a removal mechanism.

Removal mechanism 215 is connected to an exit door 350 via arms 342. Arms 342 are connected to a rod 444 engaged via joint 446 to guide channel 344. Removal mechanism 215 is raised from fluid vessel 224 by raising arm 342 along guide channel 344. Removal mechanism 215 is also coupled to product removal door 350 via arms 342 such that when the removal mechanism is raised, the product removal door opens to allow access to and removal of the coated substance from the interior of machine 200. In some embodiments, the removal door is operated independently from the removal mechanism.

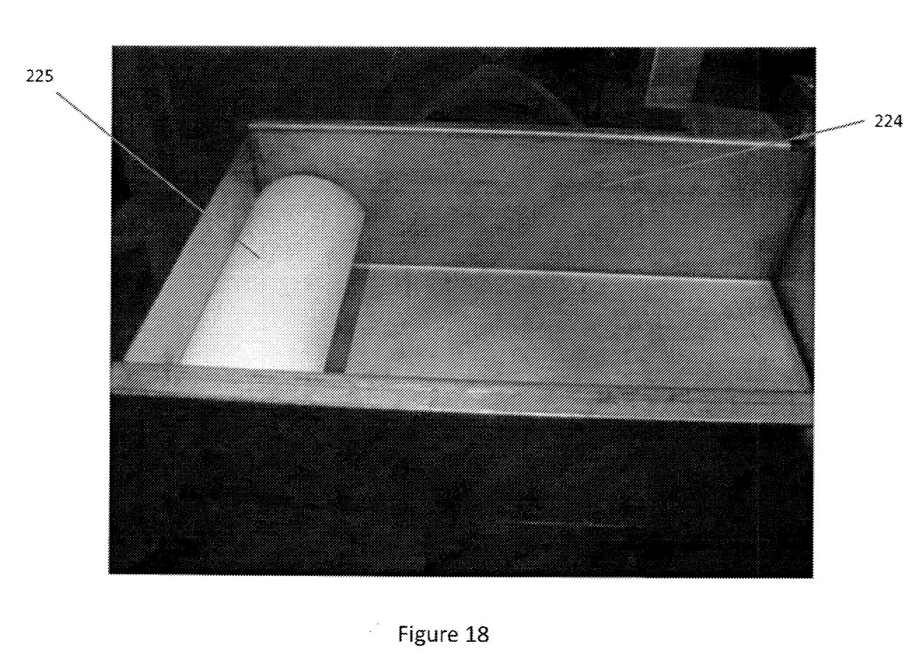

Referring to FIG. 18, a fluid-displacing insert 225 can be placed within fluid vessel 224 and/or fluid vessel 222. Insert 225 reduces the volume of fluid necessary to fill the fluid vessel 224 or 222 and can have an elliptical/circular/hemispherical/airfoil or other smooth cross section. Due to its rounded shape, the insert 225 redirects the flow of fluid. This is particularly advantageous for high viscosity fluids (e.g., alginate) as they do not flow as easily as low viscosity fluids (e.g., water). When a large, flat, horizontal object such as removal mechanism 215 or receptacle 214 is lowered into the fluid-filled vessel the viscous fluid therein is redirected by insert 225 to cover the top of the object. The insert typically runs along the complete length or width of the fluid vessel, although a small (e.g., 1-10 mm) gap between the insert 225 and the side of the fluid vessel is also permissible. The insert 225 is sized so that it can displace 5-50% of the fluid vessel volume. The insert 225 can be connected to the bottom of the fluid vessel or attached to the sides only.

While a number of embodiments has been described above, it will be understood that that various modifications may be made. For example, machine 200 can include one, or a plurality of processing stations. The processing stations can sequentially receive, transfer, and process an flowable substance (e.g., a consumable substances such as foods, drinks, medicines, etc.), which can be a fluid, solvent, emulsion, colloidal suspension, and the like, so as to encapsulate the flowable substance in at least one membrane (e.g., an edible membrane, a biodegradable membrane, etc.).

The flowable substance is sufficiently flowable to be extruded from an extrusion outlet. The flowable substance can carry dispersed solid, edible particulates (e.g., pieces of chocolate in a flowing chocolate mousse), such that the entirety of the substance is extrudable from an extrusion outlet. Various delivery hoses, pipes or lines can additionally be treated with non-stick compounds (e.g., PTFE), electrically charged compounds, hydrophobic surfaces and the like to impart a variety of flow characteristics to the extrudable substances.

In another example, the exemplary machine 200 dispenses the payload to be coated from above with gravity pulling the payload down to the receptacle 214 of the first processing station 202. However, some embodiments can be extruded the payload upward into a receptacle fluid. Factors including the relative specific gravity of the payload and the coating fluids and the viscosity of the payload are considered in determining the appropriate approach. Examples of systems in which the payload is discharged upwards are described in in WO 2011/103594 filed Feb. 22, 2011 which is incorporated herein by reference in its entirety.

In some embodiments, one component of the membrane can be a gelling or polymerizing precursor (e.g., a polymer, a hydrogel such as alginate, etc.), while the other component is a crosslinking agent (e.g., a multivalent ionic species such as calcium, magnesium, manganese, other divalent or trivalent cations or anions. etc.) for the gelling or polymerizing precursor. In some embodiments, the crosslinking agent is dissolved in a solution (e.g., solubilized). In certain cases, the crosslinking agent can be in the form of a suspension in a fluid. In some embodiments, the crosslinking agent and the gelling or polymerizing precursor together form a salt-bridge network.

In some embodiments, the edible or potable substance includes one component of the edible or biodegradable membrane, and the first processing station includes another component of the edible or biodegradable membrane. For example, the edible or potable substance can include a gelling or polymerizing precursor, while the first processing station can include a crosslinking agent, or vice versa. An optional processing station can include a flavoring, powder, wash, or storage solution such as a liquid/powder bath or spray station. The optional second processing station can receive the edible or biodegradable membrane-coated edible or potable substance between for example, an alginate bath station and a calcium bath station.

Operation

In use, receptacle 214 is optionally lowered and raised from fluid vessel 222 to fill each cell 307 with a fluid (e.g., an alginate solution, etc.) contained within fluid vessel 222. Extrusion outlets 212 then dispenses a substance into one or more corresponding recipient cells in receptacle 214, and excess fluid drains from openings 309. Receptacle 214 is then be lowered into and raised from fluid vessel 222 in first processing station 202, where the substance is coated with the fluid contained within fluid vessel 222 and excess fluid can drain from openings 309 back into fluid vessel 222. Receptacle 214 carrying a coated substance then moves from the first processing station 202 toward the second processing station 204, along guide channel 216. At second processing station 204, cogs 326 on rotatable joint 324 (connected via arm 322 to receptacle 214) engage with teeth 330 at a topmost portion of channel 328 and move down channel 328, thereby rotating receptacle 214 to gently drop the coated substance into removal mechanism 215. The removal mechanism 215 then lowers to submerge the coated substance into a fluid (e.g., a calcium solution, etc.) contained within fluid vessel 224 of the second processing station 204. In some embodiments, removal mechanism 215 is submerged in the fluid vessel 224 and the coated substance is dropped directly into the fluid vessel from the receptacle 214. After a stabilized membrane is formed over the surface of the coated substance, the removal mechanism 215 is raised out of the fluid in fluid vessel 224 raising the coated substance out of the bath. Excess fluid can drain from removal mechanism 215, and the membrane-coated substance can be removed from the machine via an opened side door 350.

In some embodiments, when an extrusion outlet 212 has multiple tubes and openings, such as two concentric tubes 502 and 504 shown in FIG. 14, one tube (e.g., an outer tube) can extrude one component of the edible or biodegradable membrane. For example, outer tube 502 can extrude a substance including alginate and/or a charged molecule that facilitates gel formation with a multivalent ion (e.g., calcium). Inner tube 504 can extrude a liquid, emulsion, or foam. Extrusion outlet 212 can thus directly extrude the contents of both the inner and outer tubes into a crosslinking agent solution that is contained in fluid vessel 202. In some embodiments, the flow rates of the inner and outer tubes are independently controlled. For example, referring to FIG. 14, when L1 is greater than zero, inner tube 504 can extrude an inner liquid to opening 514, and outer tube 502 can extrude an outer liquid to opening 512. When the inner liquid exits opening 514, contact is made between the outer and inner liquids as the inner liquid enters the interstitial space between the inner and the outer tubes.

In some embodiments, extrusion outlet 212 directly extrudes the contents of the inner and outer tubes into a calcium solution in fluid vessel 202. Outer tube 502 can extrude, for example, an alginate, chitosan or other membrane forming liquid at a rate sufficient to supply a membrane-forming component, as needed, during the extrusion of the inner liquid. Extrusion can continue until a droplet of inner liquid surrounded by a membrane gel layer is formed inside the metal ion (calcium) bath. The droplet can then be separated (e.g., either mechanically or manually) from the tip of the extrusion outlet. The machine can be operated in continuous or batch mode. The droplet is coated with a stable crosslinked membrane in the metal ion bath. A second droplet can be subsequently formed in a similar manner. The crosslinked membrane-coated droplets can then be removed from fluid vessel 202 and transferred to fluid vessel 204, which can contain a wash or storage solution such as water.

Automation

Machine 200 is manually operated. Referring back to FIG. 8, a user first uses a knob 392 (located on the back of machine 200) that is connected to joint 324 to submerge and raise receptacle 214 from fluid vessel 222 of first processing station 202. Cells 309 are filled with a first fluid (e.g., a membrane forming material such as an alginate solution, chitosan, etc.) from fluid vessel 222. The user then rotates crank 390 in a clockwise direction to extrude a quantity of substance from extrusion outlets 212 into cells 309 of receptacle 214. Excess fluid (e.g., a displaced alginate solution, etc.) is drained from receptacle 214 via openings 309. The user then uses knob 392 to move receptacle 214 along guide channel 216 toward second processing station. Cogs 326 engages with teeth 330, and the receptacle rotates around joint 324 to deliver the coated substance into perforated tray 215 submerged in a second fluid (e.g., an activating agent such as a divalent or trivalent metal solution (e.g., calcium, magnesium, etc.)) of fluid vessel 224. Referring again to FIG. 8, the user then raises perforated tray 215 from fluid vessel 224, using knob 394 (located on the back of machine 200). Excess fluid (e.g., excess calcium solution, etc.) is drained from perforated tray 215. Product removal door 350 also opens as knob 394 is raised. The user can then remove the substance that is now coated with a membrane, from the perforated tray using the product removal door opening.

In some embodiments, an entirety of machine 200, or parts thereof (e.g., an extrusion apparatus or parts thereof, such as a supply pump, conduit 303 and 305, individual conduit 303a, 305a, etc., replacement and/or replenishment of reservoirs 372 and 374, or extrusion outlets 212; receptacle 214; replacement and/or replenishment of fluid vessels 222 and 224; transfer of a product from receptacle 214 from fluid vessel 222 to 224; removal of the product from perforated tray 215; opening and closing of product removal doors; repositioning of receptacle 214 and perforated tray 215; etc.) can be operated manually or using an automated system. When machine 200, or parts thereof, is automated, the automated parts can be coupled to a controller which can control timing and movement of the automated parts.

The devices described can incorporate various sensors (e.g., pH sensors, dielectric sensors, conductance sensors, temperature sensors, liquid volume level sensors, pressure sensors, etc.). For example, liquid volume level sensors in baths and reservoirs can be used to monitor when baths need to be refilled. Pressure sensors disposed, for example, on hoses, reservoirs, nozzles, etc. can be used to assess whether clogging is occurring and system cleaning is needed. Density sensors in the fluid baths can be used to assess the extent to which fluids in the baths are being diluted and when they should be refreshed.

### EXAMPLE 3

### Preparation of a Stable and Mechanically Robust Gellan Gum for Liquid Encapsulation

In one embodiment, we prepared a transport and storage container with gellan gum modified by a calcium external shell. Gellan gum is also a polysaccharide, consisting of two residues of D-glucose and one of each residues of L-rhamnose and D-glucuronic acid. Gellan gum is produced by the bacterium Sphingomonas elodea. This polysaccharide is also considered a promising candidate, since (i) it is also a water-soluble polysaccharide and easy to use; (ii) the sol-gel transition occurs by heating/cooling thermal treatment (physical gelation) without using a chemical agent (such Ca²⁺). Consequently, the process to form the initial volume is simpler than the step (d) in FIGS. 5A; (iii) the gel is very stable, since it is able to withstand 120° C. heat (this T_{gel} is higher than the agar-agar, carrageen or alginate value), making it especially useful in culturing thermophilic organisms for example; and (iv) contrary to alginates, the gel is mechanically very stable and rigid, and it keeps the form perfectively.

We have realized a sphere (8 cm diameter) composed with gellan gum membrane by two processes. The first process consists of placing the frozen liquid in a gellan gum hot solution. As the surface of the solid is cold, the gelation occurs suddenly. We can use liquid nitrogen to increase the thickness of the membrane. The solid volume is then extracted from the gellan solution. The solid melts slowly into a liquid, which is then embedded in a gellan membrane.

The second process produces a smoother external surface, as:

(a) Gellan gum is dissolved in boiling water. A high concentration (>4% in mass) is required to get a robust membrane, which must compensate the weight of a high volume of liquid.

(b) While the gellan gum solution is still hot (i.e. T>T_{gel}), the liquid is introduced into a mould. (In our example, the mold has the form of two half spheres, which are then linked). This technique allows angles, and thus design, of complex volumetric shapes.

(c) The temperature is decreased to below T_{gel}. The mold is removed. At the end of this step, we obtain a solid volume, empty (hollow) inside.

(d) The liquid (water for example) can be injected into the volume.

(e) The hole (caused by the syringe) is closed by using a hot (T>T_{gel}) needle.

From a culinary point of view, this process allows chefs to create a cocktail (cold or hot) wherein the glass (volume container) can be completely edible (and an integral part of the cocktail). Of course, it can be extrapolated towards many preparations, and this process can be extended to different fields of applications.

The next step is to chemically-modify the gellan gum to produce a rugged external surface (as done with the alginates in the example above). While it is possible to chemically modify gellan gum by methacrylation (as we did with alginate), and to photo polymerize the membrane, we chose here to reinforce the membrane by an in-situ crystallization in the gel. In this case, we immersed our gellan sphere in a concentrated carbonate solution (Na₂CO₃) and convected (e.g., heated) the solution past the sphere. Then, we immersed the gellan sphere in calcium solution (CaCl₂) and convected the solution again. In the gel, the crystallization of calcium carbonate occurs quickly: Ca²⁺+CO₃²⁻→CaCO₃(K=4×10⁹). This process allows us to build up a solid membrane of calcium carbonate as with an egg shell (i.e. particles of calcium carbonate particles are embedded in the gellan gel matrix). The external membrane becomes hard and resistive and can be made particularly thick with long convection (heating) exposure time of the calcium carbonate solution. The concentration of CO₃²⁻ and Ca²⁺ in solutions and time of immersion in batches are parameters to be controlled to obtain a rigid and inert membrane as in an egg shell.

### EXAMPLE 4

### Food Particle-Containing Alginate Shells

By adjusting the properties of the alginate solution contained in the third processing station, the membrane can be designed to be stronger, thinner/thicker, or taste in a particular way, by adding suspended particles of food, e.g. chocolate, nuts, caramel, orange rind, or other particles at least partially insoluble in water. The particles can be sized (e.g., chosen , formed, etc.) such that the maximum dimension of the container formed by the membrane is about 50 or 100 times larger (or more) than the maximum dimension of the particles.

Often these particles will be charged (i.e. most particle surfaces have some charge or zeta potential). This charge can be modified by the way each particle is created, its size, and the nature of the particle surface. Surfactants can be added to enhance the charged nature and the ionic atmosphere of the water can also be modified beneficially. When in alginate, or aqueous medium, these particles (assuming they are zwitterionic or oppositely charged to the membrane forming material, such as the alginate) will undergo strong or weak associations with alginate but not so strong as to cause gel formation. When in contact with calcium, for example, particles will form with alginate a gelled membrane through interaction of the calcium and food particles trapped within the membrane, possibly strengthening it, improving flavor, etc. The maximum weight of the added material (e.g., chocolate particles) relative to the alginate, might be quite large, i.e., significantly larger than 1:1 ratio of particles to alginate by mass. This will depend on the desired membrane nature as well as the nature of the particles and the interactions they may have with calcium and alginate.

These same methods can be extended to any kinds of small particles with a charge, thus creating a new class of membrane, formed by a charged polymer, such as alginate, and charged particles, with or without the addition of a multivalent cation such as calcium.

Chocolate-Containing Alginate Shells

The properties of the alginate solution contained in the third processing station can be adjusted to lower the alginate concentration in water to 1.8% by weight and formed orange juice containers with membranes made with high, medium, and low concentrations of chocolate particles between about 0.1 and 5% chocolate particles by weight.

Almond-Containing Alginate Shells

Similarly, the alginate solution contained in the third processing station can be adjusted to form containers with membranes made with alginate solutions with 6% food particles. The food particles included almond powder and, in some instances, various fruit powders. The almond powder had particles on the order of tens and hundreds of microns and was purchased retail in this form from the Vahinéfood company in France. We formed containers with membranes made with alginate solutions with 6% food particles by dissolving/mixing 6.4 g ground almond powder into 100 g of an alginate solution (1.8% alginate). The alginate solution with almond powder produced a relatively opaque fluid (milky/creamy color), and maintains the fluidity of the original sodium alginate solution over time (at least 3-5 days). The almond combination seems to color and make fluid surrounding individual almond particles more opaque or at least translucent. In contrast, in the “sodium alginate solution+chocolate particles” membrane discussed above, the chocolate particles, except when observing an individual chocolate particle directly, do not appear to produce a more generally opaque substance. The particle size, shape, and quantity all play integral roles in these phenomena.

We also formed containers with membranes made with alginate solutions with 6% food particles by dissolving 6.4 g ground coconut powder into 100g of an alginate solution (1.8% alginate) that could be made using the machine 100. The coconut pieces had small, generally crescent-like shapes with characteristic size on the order of hundreds of microns or several (1-3 or more) millimeters. The powder was purchased from Vahinéin France. The alginate solution with coconut powder maintains the fluidity of the original sodium alginate solution over time (at least 3-5 days). This mixture did not visibly have the effect of increasing overall opacity (beyond line-of-sight opacity of the coconut particles themselves) as seen in the almond mixture. By placing a high proportion of coconut powder into the alginate solution, opacity could be increased. Beyond a certain proportion of coconut particles in the mixture, however, the membrane ultimately was found to be more permeable when in container form, and at higher risk of leaking. Particle size and shape may play an important role in the transparency, in particular as compared to the almond powder example noted above, since the coconut particles used were generally larger. There was little or no visible dissolution of coconut particles in the solution. It was also noted that when left to sit, the mixture of coconut pieces and alginate solution did not result in a substantial proportion of coconut pieces settling to the bottom. Such settling was found to be the case with many other food particles tested with alginate solution. The taste of the coconut membrane was found to relatively strong.

We also formed containers with membranes made with alginate solutions with 6% food particles by dissolving 4.0 g ground almond powder and 2.4 g ground lyophilized mango powder into 100 g of an alginate solution (1.8% alginate) that could be made using the machine 100. This solution remained fluid for a certain time, but we noted that the fluidity had decreased considerably within roughly 50 hours. As such, we could still add additional mango powder to increase the fruit flavor, without losing too much fluidity. This mixture did not have the effect of increasing overall opacity as seen in the almond mixture. Particle size and shape may play an important role in the transparency, in particular as compared to the almond powder example noted above, as the mango particles used were larger, ranging from hundreds of microns to several millimeters, and had various non-uniform shapes.

We also formed containers with membranes made with alginate solutions with 6% food particles by dissolving 6.0 g ground almond powder and 0.4 g ground lyophilized raspberry powder into 100 g of an alginate solution (1.8% alginate) that could be made using the machine 100. This combination produced a fluid that solidified relatively quickly (faster than the mango example), i.e., within a few (1-4) hours. It was noted that to a certain extent the (red) color of the raspberry spread throughout the fluid, making it translucent, even where solid raspberry particles were not present.

We also formed containers with membranes made with alginate solutions with 6% food particles by dissolving 6.0 g ground almond powder and 0.4 g ground lyophilized blackcurrant powder into 100 g of an alginate solution (1.8% alginate) that could be made using the machine 100. This combination produced a fluid that solidified into a relatively hard gel fastest: 10 minutes to an hour. The fruit also somewhat colored the overall fluid to make it translucent.

The machine 100 can also apply alginate solutions mixed with dried fruit powders (e.g., raspberry and blackcurrant powders) that produced relatively rapid “gelification”, or a hardening of the fluid into a more solid gel. It is hypothesized that a property of the fruits tried or a substance contained within them, such as acidity/acids, plays a role in this gelification process, perhaps in effect replacing the cations provided by, for example, calcium chloride solution in other examples noted separately. It appears that blackcurrant is a more rapid “gelling agent” than raspberry, perhaps owing to greater acidity. It is possible that this gelling process obviates the need for other gelling components/steps such as with calcium chloride as described elsewhere.

These observations suggest that, in order to have a membrane with substantial fruit (e.g. raspberry or blackcurrant) flavor, it is sometimes useful to use many small aggregated “chunks” or “chips” of fruit powder, rather than a homogeneous mixture of alginate solution and fruit powder, to create individual, point-like flavorful fruit pieces within the membrane. In the mango example, slower hardening/gelification allowed for a greater amount of mango powder to be added, to enhance taste, without an immediate loss of fluidity. The chocolate particles used in other examples resulted in a less strongly flavored solution/membrane than many of the fruit combinations described here.

The relatively high opacity produced by the almond powder membrane, and the translucence/semi-opacity produced in other sample membranes, can be useful for aesthetic and/or culinary purposes. The size and shape of the particles in the various powders used likely plays an important role in the opacity/translucence of the solution. The almond powder, for example, was finer than previously used chocolate powders; this may help explain the increased opacity. The properties of the particles also likely play a role in the “strength” and/or permeability of the eventual container.

Other approaches and formulations for membranes and shells that can be formed by the devices described in this disclosure are discussed in U.S. Patent Application No. 61/591,054 (Attorney Docket No. 24832-0032P01), U.S. Patent Application No. 61/591,233 (Attorney Docket No. 24832-0033P01), and U.S. Patent Application No. 61/591,262 (Attorney Docket No. 24832-0034P01), all filed on Jan. 26, 2012, the entire contents of which are hereby incorporated by reference in their entirety.

### EXAMPLE 5 Transfer Assembly

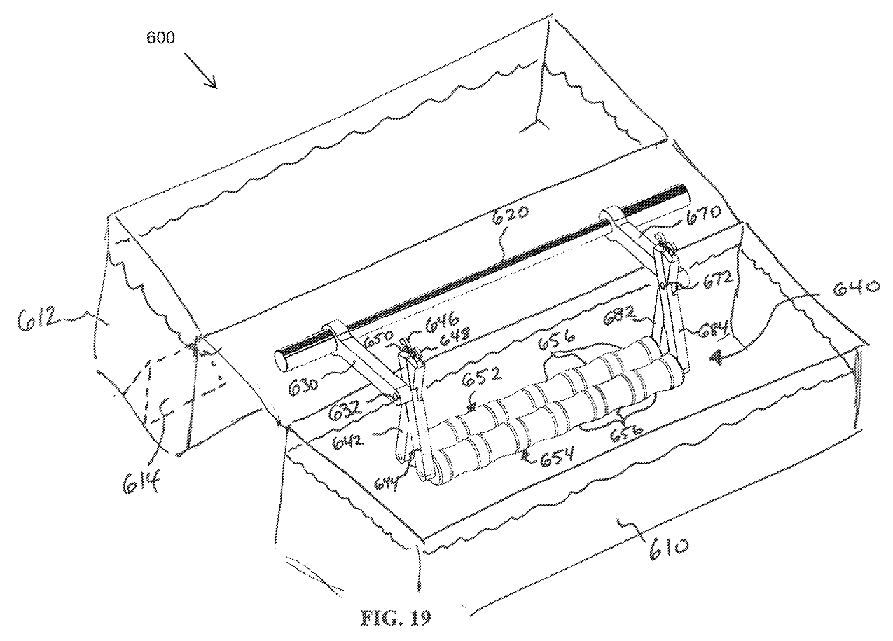

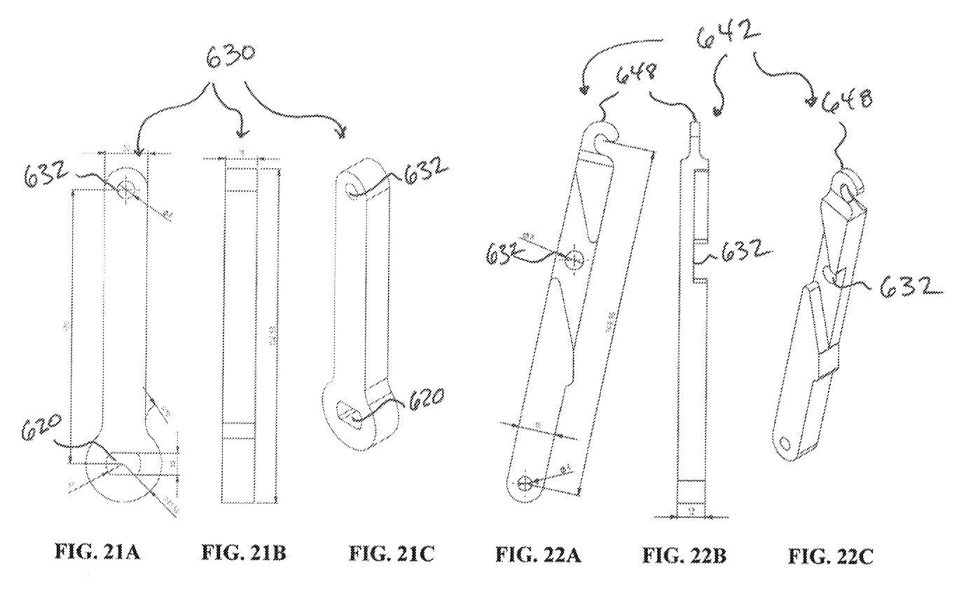

In the depicted embodiment, a system 600 is provided for transferring an edible payload 700 between stations or fluid baths. As shown in FIG. 19, the system 600 includes a first fluid bath 610 and a second fluid bath 612. A first arm 630 and a second arm 670 extend from a pivot axis 620. Detailed illustrations of an exemplary first arm 630 are shown in FIGS. 21A, 21B, and 21C. A structure may be provided at the pivot axis 620 for connection of the first arm 630 and the second arm 670. Each of the first arm 630 and the second arm 670 may be orthogonal to the pivot axis 620. Each of the first arm 630 and the second arm 670 are rotatable about the pivot axis 620. The first arm 630 and the second arm 670 are configured to support a transfer assembly 640. The transfer assembly 640 is connected to the first arm 630 at a first pivot point 632 and to the second arm 670 at a second pivot point 672. While described herein as a “point,” it will be appreciated that the first pivot point 632 and/or the second pivot point 672 may be larger than a point, such as including a pin.

In the depicted embodiment, the transfer assembly 640 is configured to freely swing or rotate about the first pivot point 632 and the second pivot point 672, regardless of the rotational orientation of the first arm 630 or the second arm 670. As such, the transfer assembly 640 is subject to a force of gravity and may maintain a uniform or substantially uniform orientation relative to the first pivot point 632 and/or the second pivot point 672 during operation. As the first arm 630 and the second arm 670 rotate about the pivot axis 620, the transfer assembly 640 may freely swinging such that its center of mass remains below the first pivot point 632 and/or the second pivot point 672.

In the depicted embodiment, the transfer assembly 640 includes a first bar 642 and a second bar 644. In other embodiments, only one bar may be provided, or more than two bars may be provided. Detailed illustrations of an exemplary first bar 642 are shown in FIGS. 22A, 22B, and 22C. The first bar 642 and the second bar 644 may extend from the first pivot point 632 or from another location connected to the first pivot point 632. In the depicted embodiment, the transfer assembly 640 includes a third bar 682 and a fourth bar 684. The third bar 682 and the fourth bar 684may extend from the second pivot point 672 or from another location connected to the second pivot point 672. The first bar 642 and/or the third bar 682 may connect to a first beam 652. The first beam 652 may extend from one of, or between, the first bar 642 and the third bar 682. The second bar 644 and/or the fourth bar 684 may connect to a second beam 654. The second beam 654 may extend from one of, or between, the second bar 644 and the fourth bar 684. In the depicted embodiment, the first beam 652 is parallel to the second beam 654.

In some embodiments, the transfer assembly 640 has a closed configuration, in which the first beam 652 is adjacent to, contacting, or near the second beam 654. In the closed configuration, the first beam 652 and the second beam 654 are configured to receive, capture, cradle, or support a payload 700. For example, in the closed configuration, a distance between the first beam 652 and the second beam 654 does not exceed a maximum cross-sectional dimension of the payload 700. In some embodiments, the transfer assembly 640 has an open configuration, in which the first beam 652 is relatively farther displaced from the second beam 654 than while in the closed configuration. In the open configuration, the first beam 652 and the second beam 654 are configured to drop, deliver, or release a payload 700. For example, in the open configuration, a distance between the first beam 652 and the second beam 654 exceeds a maximum cross-sectional dimension of the payload 700.

In the depicted embodiment, the first beam 652 and/or the second beam 654 include one or more dimples 656. A first dimple of the first beam 652 and a second dimple of the second beam 654 may form a corresponding pair. Corresponding pairs of dimples 656 may be aligned at adjacent locations collectively forming a receiving location for a payload 700. The dimples 656 may be defined as a portion of the first beam 652 or the second beam 654 having a smaller cross-sectional dimension than is provided at other locations along the first beam 652 or the second beam 654. Other geometries or shapes of the beams are contemplated.

In the depicted embodiment, the transfer assembly 640 further includes a first clasp 648 connected to the first bar 642 and a second clasp 646 connected to the second bar 644. The first clasp 648 and the second clasp 646 may be connected to the first bar 642 and the second bar 644, respectively, such that relative motion of the first clasp 648 and the second clasp 646 effect relative motion of the first bar 642 and the second bar 644. For example, the first clasp 648 and the second clasp 646 may be positioned on a side of the first pivot point 632 opposite that of the first bar 642 and the second bar 644, such that when the first clasp 648 and the second clasp 646 move away from each other, the first bar 642 and the second bar 644 also move away from each other. By further example, when the first clasp 648 and the second clasp 646 move toward each other, the first bar 642 and the second bar 644 also move toward each other. A biasing member 650, such as a spring, elastic, or flexible member, may be provided across the first clasp 648 and the second clasp 646. The biasing member 650 may bias the first clasp 648 and the second clasp 646 toward or away from each other. Accordingly, the biasing member 650 results in the first beam 652 or the second beam 654 being biased toward each other (e.g., in the closed configuration) or away from each other (e.g., in the open configuration). Alternatively, the biasing member 650 may be provided across the first bar 642 and the second bar 644.

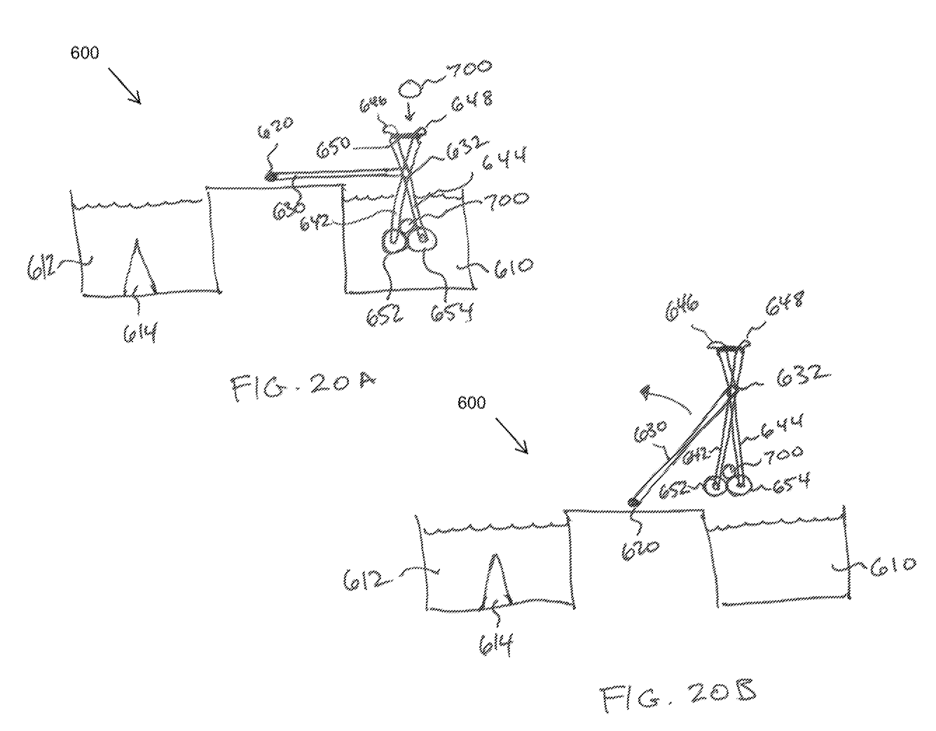

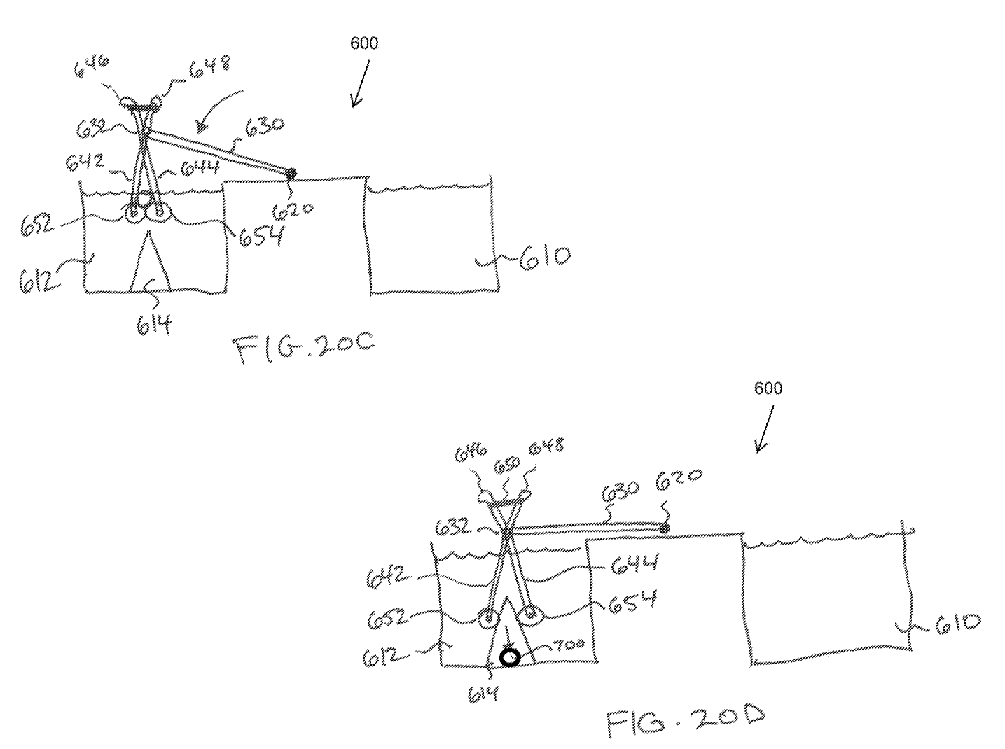

In the depicted embodiment, as shown in FIG. 20A, a payload 700 is delivered to the transfer assembly 640 while the first beam 652 and the second beam 654 are at least partially within the first fluid bath 610 and while the transfer assembly 640 is in the closed configuration. The payload 700 rests across the first beam 652 and the second beam 654 in the first fluid bath 610. The dwell time of the payload 700 in the first fluid bath 610 may be any amount of time. For example, the payload 700 may be maintained in the first fluid bath 610 for an amount of time sufficient to coat the payload 700 or change the temperature of the payload 700.

As shown in FIG. 20B, at least the first arm 630 is rotated about the pivot axis 620, such that the transfer assembly 640 and the payload 700 are lifted from the fluid bath 610. While the first arm 630 rotates about the pivot axis 620, the transfer assembly moves translationally along an arcuate pathway. At the same time, the transfer assembly 640 may maintain a constant or substantially constant orientation by pivoting relative to the first arm 630 about the first pivot point 632.

As shown in FIG. 20C, the first arm 630 may be rotated about the pivot axis 620 sufficient to bring at least a portion of the transfer assembly 640 and the payload 700 into the second fluid bath 612. As shown in FIG. 20D, the first arm 630 may be rotated about the pivot axis 620 sufficient to bring at least a portion of the transfer assembly 640 into contact with a separator 614. The separator 614 may be located within the second fluid bath 612 at a location in which it will interact with at least a portion of the transfer assembly 640. The separator 614 may be a rigid or semi-rigid structure. The separator 614 may be a wedge or other tapered structure configured to separate the first beam 652 from the second beam 654 when the transfer assembly 640 is brought into contact with the separator 614. Such separation may occur against a force provided by the biasing member 650. As shown in FIG. 20D, when the transfer assembly 640 contacts the separator 614, the transfer assembly 640 may achieve the open configuration, in which the first beam 652 separates from the second beam 654 sufficient to allow the payload 700 to drop freely from the transfer assembly 640. The payload 700 may remain within the second fluid bath 612 for a dwell time sufficient to coat the payload 700 or alter its temperature. Subsequently, the payload 700 may be removed from the second fluid bath 612 by various means.

After release of the payload 700, the transfer assembly 640 may return to the first fluid bath 610 by rotation of the first arm 630 about the pivot axis 620. After terminating contact with the separator 614, the transfer assembly 640 may recover to the closed configuration (e.g., by action of the biasing member 650). While in the closed configuration and within the first fluid bath 610, the transfer assembly 640 is prepared to receive an additional payload 700.

### Other Embodiments

A number of embodiments have been described. Nevertheless, it will be understood that various modifications may be made without departing from the spirit and scope of the invention.

While the machines, systems, and methods disclosed herein have been described as being configured to receive, handle, and enclose a typically frozen substance in a membrane, other approaches are possible. For example, in some embodiments, a liquid or semi-solid inner material (e.g., in a non-frozen state) that contains divalent cations is dispensed directly into an alginate solution to form an initial membrane layer that is structurally suitable for handling the inner material and the membrane layer. The membrane-covered inner material can then be removed from the alginate solution (e.g., lifted from the alginate solution), in some cases then submerged in calcium solution (e.g., lowered into the calcium solution), and then further processed in a similar manner as described above, for example, with reference to the machine 100.

The alternative approach can thus reduce or eliminate the steps of freezing the inner material to form a frozen object to be submerged in liquid nitrogen, a first calcium solution, an alginate solution, and then a second calcium solution. Additionally, the machine for producing the transport system can be simplified, for example, by eliminating the processing station having a liquid nitrogen bath. Other details and disclosure about transport systems formed using non-frozen inner materials containing divalent cations can be found in contemporaneously filed U.S. Provisional Patent Application No. 61/601,852 [Attorney Docket No. 24832-0032P02], filed on Feb. 22, 2012, the contents of which are incorporated herein by reference in their entirety.

In another example, food transport systems can also be formed by spraying droplets of food liquid from a tube with an annulus around the tube that sprays an enveloping membrane material. In one embodiment, the tube sprays water containing calcium and the annulus sprays chemically-modified alginates as described above. When the droplets come out of the tube covered with the membrane, the droplets are exposed to UV light and possibly suspended in the air for some period of time to be allowed to harden.

In another example, the droplets may be sprayed with just a sodium alginate membrane and, in the air, coated with the chemically modified alginates as described above. The droplets would then be exposed to UV light and possibly suspended in the air for some period of time to be allowed to harden.

In another example, the droplets may be sprayed with a sodium alginate membrane and, in the air, hardened/cured with calcium as described above.

In some embodiments, containers include a PLA outer shell and use inner membranes ranging from the sodium alginate membranes to edible waxes of the kinds used on fine chocolates occasionally. The latter have a distinct advantage of repelling water. Some embodiments may contain one or more combinations of such materials as “shells” or “membranes”, for example, a sodium alginate membrane, hardened/cured with calcium, may be covered with a wax and then placed within a PLA shell.

In some embodiments, multiple inner containers can be protected by a single outer shell. For example, in some embodiments, a shell of PLA is filled with ‘grapes’ of liquid and closed up like a bottle. The outer shell can be opened and the ‘grapes’ consumed with the liquid they contain. The outer shell is biodegradable and the advantage of the inner membranes is to reduce direct contact of water bottle and water and therefore avoid degradation of the bottle itself.

A number of embodiments have been described. Nevertheless, it will be understood that various modifications may be made without departing from the spirit and scope of the disclosure. Accordingly, other embodiments are within the scope of the following claims.

1-51. (canceled)

52. A system for transferring a payload between fluid baths, comprising:
a first fluid bath:
a second fluid bath:
a first arm extending from a pivot axis to a first pivot point, the first arm being rotatable about the pivot axis: and
a transfer assembly attached to the first arm at the first pivot point, the transfer assembly being rotatable about the first pivot point and comprising (i) a first bar extending from the first pivot point to a first beam and (ii) a second bar extending from the first pivot point to a second beam, the second beam being parallel to the first beam.

53. The system of claim 52, wherein the transfer assembly has a closed configuration, such that the first beam contacts the second beam, and an open configuration, such that the first beam is separated from the second beam.

54. The system of claim 52, wherein the first arm has a first rotational configuration, such that the first pivot point is positioned over the first fluid bath and the first beam and the second beam are within the first fluid bath, and a second rotational configuration, such that the first pivot point is positioned over the second fluid bath and the first beam and the second beam are within the second fluid bath.

55. The system of claim 52, wherein the first beam and the second beam are biased to contact each other.

56. The system of claim 52, wherein the first bar extends from the first pivot point away from the first beam to a first clasp and the second bar extends from the first pivot point away from the second beam to a second clasp.

57. The system of claim 56, further comprising a biasing member connecting the first clasp to the second clasp.

58. The system of claim 57, wherein the biasing member comprises an elastic material.

59. The system of claim 52, wherein the second fluid bath comprises a rigid separator configured to separate the first beam from the second beam while the transfer assembly is at least partially in the second fluid bath.

60. The system of claim 52, wherein the transfer assembly is freely rotatable about the first pivot point, such that the first beam and the second beam are configured to remain vertically below the first pivot point as the first arm rotates about the pivot axis.

61. The system of claim 52, wherein each of the first beam and the second beam comprises a plurality of dimples configured to cradle the payload.

62. The system of claim 61, wherein each of the dimples of the first beam is adjacent to a corresponding one of the dimples of the second beam when the first beam is in contact with the second beam.

63. The system of claim 52, wherein the first arm is orthogonal to the pivot axis.

64. The system of claim 52, further comprising:
a second arm extending from the pivot axis to a second pivot point, the second arm being rotatable about the pivot axis:
wherein the transfer assembly is further attached to the second arm at the second pivot point, the transfer assembly being further rotatable about the second pivot point, and the transfer assembly further comprising (i) a third bar extending from the second pivot point to the first beam and (ii) a fourth bar extending from the second pivot point to the second beam.

65. The system of claim 52, wherein the pivot axis is between the first fluid bath and the second fluid bath.

66. A method for transferring a payload between fluid baths, comprising:
receiving the payload in a first fluid bath and between a first beam and a second beam of a transfer assembly, while the first beam and the second beam contact each other in a closed configuration;
transferring the payload from the first fluid bath to a second fluid bath while the first beam and the second beam maintain the closed configuration: and
releasing the payload from the first beam and the second beam by separating the first beam and the second beam in an open configuration.

67. The method of claim 66, wherein the transferring comprises: rotating an arm about a pivot axis, such that the transfer assembly, attached to the arm at a pivot point a distance from the pivot axis, freely rotates about the pivot point.

68. The method of claim 67, wherein the transferring further comprises:
maintaining the first beam and the second beam vertically below the pivot point.

69. The method of claim 66, wherein the receiving comprises cradling the payload across a dimple of the first beam and a dimple of the second beam.

70. The method of claim 66, wherein the releasing comprises bringing the transfer assembly in contact with a rigid separator, such that the first beam is on a first side of the rigid separator and the second beam is on a second side of the rigid separator.

71. (canceled)

72. The method claim 66, wherein the transferring comprises coating the payload with a substance of the second fluid bath.
